(19) United States
(12) Patent Application Publication
(10) Pub. No.: US 2001/0056498 A1
(43) Pub. Date: Dec. 27, 2001

(54) User guidance method, content advertizing method, user guidance system, object control system, moving object, storage medium and program transmission apparatus

(75) Inventors: Takenori Kohda, Yamato-shi (JP); Teruo Koyanagi, Yamato-shi (JP); Ken Masumitus, Yamato-shi (JP)

Correspondence Address: Robert P. Tassinari, Jr., Intellectual Property Law Dept., IBM Corporation, P.O. Box 218, Yorktown Heights, NY, 10598, US

(73) Assignee: International Business Machines Corporation, Armonk, NY (US)

(21) Appl. No.: 09/855,281

(22) Filed: May 15, 2001

(30) Foreign Application Priority Data
Jun. 26, 2000 (JP) 2000-197368

(51) Int. Cl. G06F 15/16

(52) U.S. Cl. 709/238; 709/217

(57) ABSTRACT

A user guidance system comprises: a moving object manager for managing the location of a moving object on a network; a radar information generator for generating information concerning the location of the moving object, and for providing the information to a user who is accessing the network; and a zero distance performer for, when the moving object is found by a predetermined user, performing a predetermined process associated with the discovery of the moving object, wherein the moving object manager arranges the moving object at a desired location in order to guide the user to desired contents on the network.

### FIELD OF THE INVENTION

The present invention relates to a method for guiding a user to a desired network site or to its content.

### BACKGROUND OF THE INVENTION

At present, a widely spread out network environment, such as the Internet, provides access to an enormous number of sites at which a great variety of reference materials are available. Therefore, it is vitally necessary that provisions be implemented for assisting and guiding users to specific sites, or site groupings, whereat information the users seek is available and can be accessed.

Conventionally, banner advertisements and search site registrations are employed as means for guiding users to specific sites. A banner advertisement is one that is linked to a predetermined commercial location. Thus, when such an advertisement is presented at a popular and often accessed site (a media site), one frequented by many users, and a user who has an innate or acquired interest in the represented subject material clicks on the advertisement, that user is connected to the site that is linked to the banner advertisement.

A search site is a site that, in accordance with a search request issued by a user, initiates a search of a network for information matching a search condition, thereby providing a service for the user. Thus, when a predetermined address is registered with a search site, and a user of the search site who is interested in the materials available at the predetermined address issues a search request, the site at the predetermined address is presented to the user as the search results, and accordingly, the user is guided to that site.

However, a conventional user guidance means can collect only those users who have knowledge of, or an interest in, the subject materials available at the address to which users are guided. That is, generally a user who is not interested in the material available at a site does not move to that site, even when he or she reads a banner advertisement. Further, such a user does not normally issue a request to search such a site.

### SUMMARY OF THE INVENTION

It is, therefore, one object of the present invention to provide means for guiding a user to specific site groups, regardless of whether or not the user has an interest in the materials available thereat.

It is another object of the present invention to provide a moving object for traveling within a specific site group in order to guide a user to that site group.

To achieve these objects, according to the present invention, a user guidance method characterized by the following configuration is provided. The user guidance method comprises the steps of: permitting an object, which is so defined that it can be obtained by a user, to appear at a specific location of a specific site; and moving the object, whereby a user who desires to obtain the object is guided to predetermined content available at the specific site.

More specifically, the step of moving the object includes the steps of: waiting, after the object has appeared at the specific location, until the object is obtained by users; and permitting the object, after the object has been obtained by any of the users, to appear at a different location at the specific site.

The user guidance method further comprises the step of: providing information, after the object has appeared, concerning the location of the object for the user who desires to obtain the object.

At the step of moving the object, the object is moved along a predetermined route, and the user who desires to obtain the object is guided to the predetermined content in accordance with a specific order based on the route.

When the user guidance method is expanded to a network, at the step of permitting the object to appear, the object appears at specific locations at multiple connected sites across the network, and at the step of moving the object, the object is moved across the network.

At the step of moving the object, the object is moved along a predetermined route across the multiple sites on the network, and the user who desires to obtain the object is guided to predetermined content available in a specific sequential order based on the route.

Further, according to the present invention, a content advertisement method characterized by the following configuration can be provided. The content advertisement method comprises the steps of: permitting an object, defined so that it can be obtained by a user, to appear on a network in contents multiple users desire to browse; and moving the object, when a predetermined user browses the contents, to contents multiple users desire to browse, whereby the user, who desires to obtain the object, is guided to and enabled to browse the contents.

At the step of moving the object, movement of the object is effected along a route that includes the contents multiple users desire to browse.

This configuration is preferable because users can browse the contents of an advertisement in a predetermined order.

In addition, according to the present invention, a user guidance system characterized by the following configuration can be provided. The user guidance system comprises: an object manager for managing the location of an object on a network; a position information generator for generating information concerning the location of the object, and for providing the information to a user who is accessing the network; and a processor for, when the object is selected by a predetermined user, performing a predetermined process associated with the object selection, wherein the object manager arranges the object at a desired location in order to guide the user to desired contents on the network. This system can be carried out simply by a predetermined server that functions as the object manager, the position information generator and the processor. Therefore, this configuration is superior, because when such a server is provided on a network, the object can be used to guide a user.

When the object is selected, the processor transmits a notification to that effect to the object manager, and upon the receipt of the notification, the object manager deletes the object selected by the user, and positions another object at a different location on the network.

Furthermore, when the object is selected by a specific user, the processor transmits, together with information (a name and ID information) concerning the specific user, a notification to that effect to the object manager. Upon the receipt of the notification, the object manager manages the information concerning the specific user, who is regarded as the person who has obtained the object. Later, if the object is selected by multiple users, among them only the specific user is regarded as the person who has obtained the object. An arbitrary rule can be employed to determine, as the person who has obtained an object, which of the users has selected the object. For example, a user indicated in the first notification that is transmitted by the processor to the object manager can be regarded as the person who has obtained the object.

Moreover, according to the present invention, an object control system having the following configuration can be provided. The object control system comprises: web servers, for storing web pages; and a main server, for communicating with a predetermined web server, wherein the main server permits a specific object to appear in a specific web page or delete from a specific web page stored in the specific web server.

The object can be selected when the object is present in a web page that a user is currently browsing. When the object is selected by the user, the main server deletes the object from the web page and permits the object to appear in another web page.

Further, the main server provides, for the user who accesses the specific web server, information concerning the location of the object that is appearing.

The information concerning the location of the object, which is provided for the user, indicates the ease with which the object can be reached from the web page browsed by the user. This information can be defined based on various relations, such as the hierarchical structure (can be extracted from the URT structure) of the locations whereat the files of web pages are stored, that are sorted into categories used by a search engine, or a connection consisting of related hyperlinks.

In addition, according to the present invention, an object control system characterized by the following configuration is provided. The object control system comprises: an object to be embedded in a web page stored at a web site on a network; and object management means for managing the location of the object on the network, wherein the object management means changes the location of the object on the network in order to move the object across the network. This system can be implemented merely by using a predetermined server that provides the object and functions as the object management means.

One control mode for the object management means correlates the location of the object with a web page browsed by a predetermined user, and changes the location of the object web pages are browsed by the user.

Further, an object control system comprises: link setting means, for storing an object in a predetermined server, instead of moving the object across a network in the above described manner, and for setting a link in a web page stored at a web site on the network in order to move to the object; and object position management means, for determining a web page for setting a link thereto, wherein, under the control of the object position management means, the link setting means changes a target web page for setting a link thereto.

Also in this case, the object position management means defines a web page browsed by a predetermined user as the target web page to which the link with the object is to be set, and changes the target web page as the predetermined user browses the web pages. And the link setting means, under the control of the object position management means, changes the link with the object.

According to the present invention, for a moving object to be embedded in a web page stored at a web site on a network, specific management means manages the location of the object on the network, and moves the object from a predetermined web page to another web page.

Furthermore, according to the present invention, a storage medium is provided on which input means of a computer stores a program in an input-enabled form, the program permitting the computer to perform: a process for permitting a specific object to appear on a specific web page stored in a specific web server; a process for, when a user browses the specific web page and selects the specific object, moving the object to another web page.

Also, according to the present invention, a program transmission apparatus can be provided that comprises: storage means for storing the above described program; and transmission means for reading the program from the storage means and for transmitting the program.

### BRIEF DESCRIPTION OF THE DRAWINGS

FIG. 1 is a diagram for explaining a network configuration for carrying out a user guidance system according to the present invention.

FIG. 2 is a diagram for explaining the concept of the invention.

FIG. 3 is a diagram for explaining the configuration of a user guidance system according to a first embodiment.

FIG. 4 is a flowchart for explaining the general processing performed by the user guidance system in FIG. 3.

FIG. 5 is a diagram for explaining the connection relationship between a page display unit and a site server according to the embodiment.

FIG. 6 is a flowchart for explaining the processing performed by a current URL manager according to the embodiment.

FIG. 7 is a flowchart for explaining the processing performed by a radar information generator according to the embodiment.

FIG. 8 is a flowchart for explaining the processing performed by a zero distance performer according to the embodiment.

FIG. 9 is a flowchart for explaining the processing performed by a moving object manager according to the embodiment.

FIGS. 10A to 10C are diagrams for explaining the processing performed by the moving object manager according to the embodiment when four requests are issued to obtain two moving objects at the same time.

FIG. 11 is a diagram for explaining the distance between URLs that are defined by using the URL structure according to the embodiment.

FIG. 12 is a diagram for explaining the distance between URLs that are defined according to the embodiment by the conceptual hierarchical structure that represents web sites that have been sorted by category.

FIG. 13 is a diagram for explaining the distance between URLs that are defined by using hyperlinks for web pages at a predetermined web site according to the embodiment.

FIG. 14 is a diagram showing an example for a radar according to the embodiment.

FIG. 15 is a diagram showing the list of modes for the network system used for the embodiment.

FIG. 16 is a diagram showing an example network configuration for carrying out a mode of the network system in FIG. 15.

FIG. 17 is a diagram showing another example network configuration for carrying out a mode of the network system in FIG. 15.

FIG. 18 is a diagram showing an additional example network configuration for carrying out a mode of the network system in FIG. 15.

FIG. 19 is a diagram showing a further example network configuration for carrying out a mode of the network system in FIG. 15.

FIG. 20 is a diagram for explaining the configuration of a user guidance system according to a second embodiment.

FIG. 21 is a flowchart for explaining the general processing performed by the user guidance system in FIG. 20.

FIG. 22 is a flowchart for explaining the processing performed by a user side moving object manager according to the embodiment.

FIG. 23 is a flowchart for explaining the processing performed by a general moving object manager according to the embodiment.

FIG. 24 is a diagram showing the list of modes for the network system used for the embodiment.

FIG. 25 is a diagram for explaining the configuration of a user guidance system according to a third embodiment.

FIG. 26 is a flowchart for explaining the general processing performed by the user guidance system in FIG. 25.

FIG. 27 is a flowchart for explaining the processing performed by a user side moving object manager according to the embodiment.

FIG. 28 is a flowchart for explaining the processing performed by a general moving object manager according to the embodiment.

FIG. 29 is a diagram showing a list of modes for the network system used for the embodiment.

### DETAILED DESCRIPTION OF A PREFERRED EMBODIMENT

The preferred embodiments of the present invention will now be described in detail while referring to the accompanying drawings.

First, an overview of the present invention will be given. According to the present invention, an object (hereinafter referred to as a moving object) is set that travels within a specific site group, and when a user searches for the moving object, the user is guided to and visits many sites in the site group, regardless of whether the user has an interest in the contents of each site that is visited. And by offering a special favor to the user who finds the moving object, supplies the motivation for a search by users for the moving object.

In the search for the moving object, a tool is employed, a radar, which is used for obtaining information concerning the location (a specific web page at a specific site) of the moving object. But instead of directly providing a user with the name of the location of the moving object, the radar provides for the user information (clues) concerning the location of the moving object, employing for the purpose the web page whereat the moving object is located and calculating the distance between that web page and the location that the user is currently browsing. Thus, the user is encouraged to travel to a number of sites whereat the moving object may possibly be present.

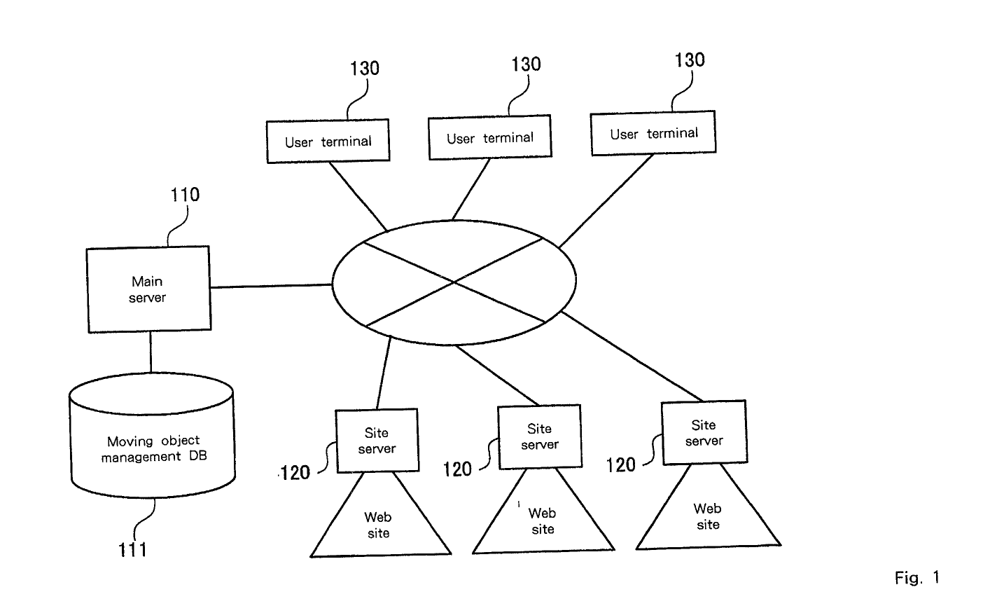

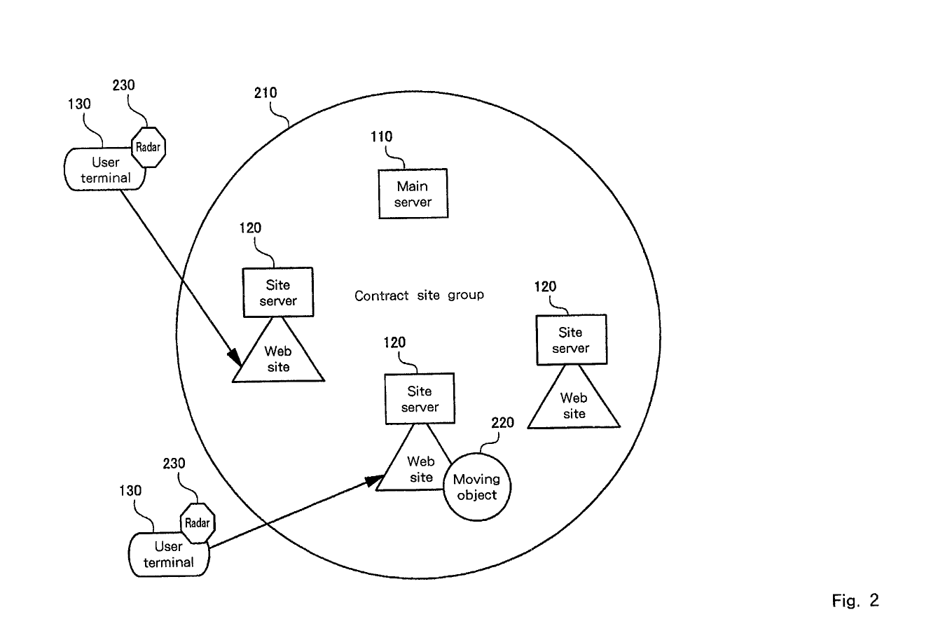

FIG. 1 is a diagram for explaining a network configuration for which a user guidance system according to the present invention is employed, and FIG. 2 is a diagram for explaining the concept of the invention based on the embodiments.

In FIG. 1, a main server 110 exercises overall control of the system. A moving object management database (DB) 111 is used to store, under the control of the main server 110, the location of the moving object and information as to whether a predetermined user has located the moving object. Site servers 120 manage web sites that store various web pages, and as is shown in FIG. 1, the main server 110, the site servers 120 and user terminals 130 are interconnected by a web base network, such as the Internet.

As is shown in FIG. 2, according to the present invention, a contract site group 210 is formed of web sites managed by site servers 120 that have agreed to enter into a contract for the use of the moving object. Then, during operation, a moving object 220, appears at a web site in the contract site group 210, which is managed by the main server 110. Thereafter, the user employs a radar 230 mounted at the user terminal 130 to search for the moving object 220. When a specific user finds the moving object 220, information concerning that user is stored in the moving object management database 111, and a special reward, established in advance, is awarded that user. Each time a moving object 220 is located, it is moved to another web site in the contract site group 210.

Next, an explanation will be given for the embodiments wherein the functional blocks for the user guidance system of this invention are provided. While roughly three embodiments will be explained, please note, however, that these embodiments can be further modified, in a variety of ways depending on where the functional blocks are set, either in a main server 110, a site server 120 or a user terminal 130.

First Embodiment

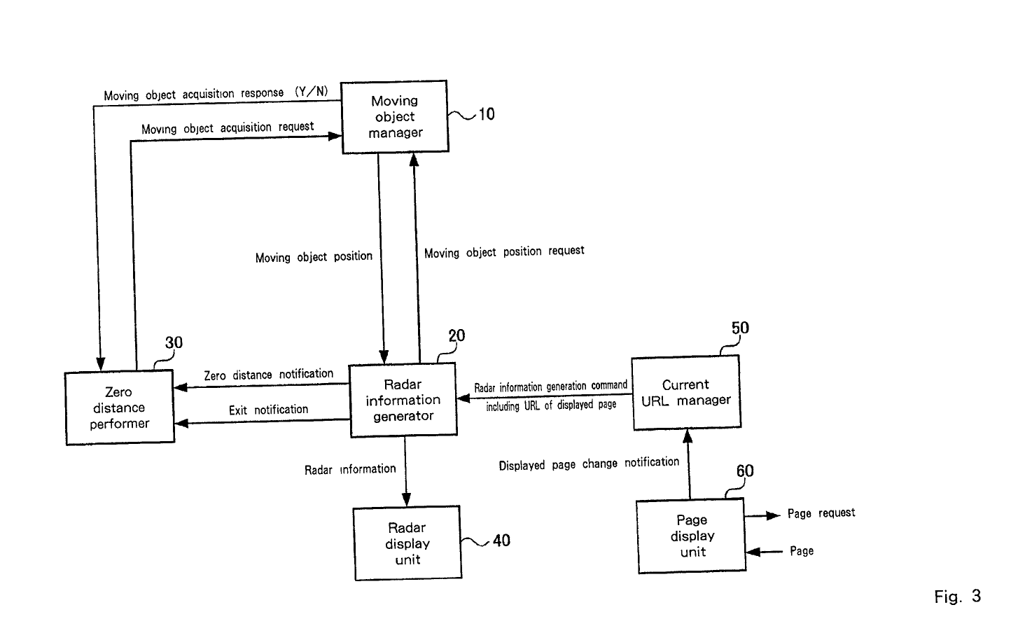

FIG. 3 is a diagram for explaining the configuration of a user guidance system in accordance with a first embodiment. In FIG. 3, a moving object manager 10 manages information, such as the location and the search status of the moving object 220. A radar information generator 20 generates relevant information (hereinafter referred to as radar information), concerning the moving object 220, that it then submits to the user. Then, when the user reaches the web page whereat the moving object 220 is located, i.e., when the user has moved to and begun browsing the pertinent web page, a zero distance performer 30 displays the moving object 220 on the web page, and performs an appropriate process when the user finds it. A radar display unit 40 then displays, on the user terminal 130, the screen for a radar 230 that includes radar information generated by the radar information generator 20. A current URL manager 50 manages the URL of the web page that the user is browsing, and a page display unit 60 displays the web page on the users terminal 130.

In this configuration, the moving object manager 10 is provided for the main server 110, and the radar display unit 40, the current URL manager 50 and the page display unit 60 are provided for the user terminal 130. Actually, the page display unit 60 is implemented by a web browser, and plug-in means, used by the radar display unit 40 and the current URL manager 50, are mounted as the functions of the web browser by using the radar information generator 20, and the zero distance performer 30 can be provided for either the main server 110, the site server 120 or the user terminal 130. In the following explanation, the locations of the radar information generator 20 and the zero distance performer 30 are not specified, and later, when modes for a network system for carrying out this embodiment are shown, a supplementary explanation for each mode will be given.

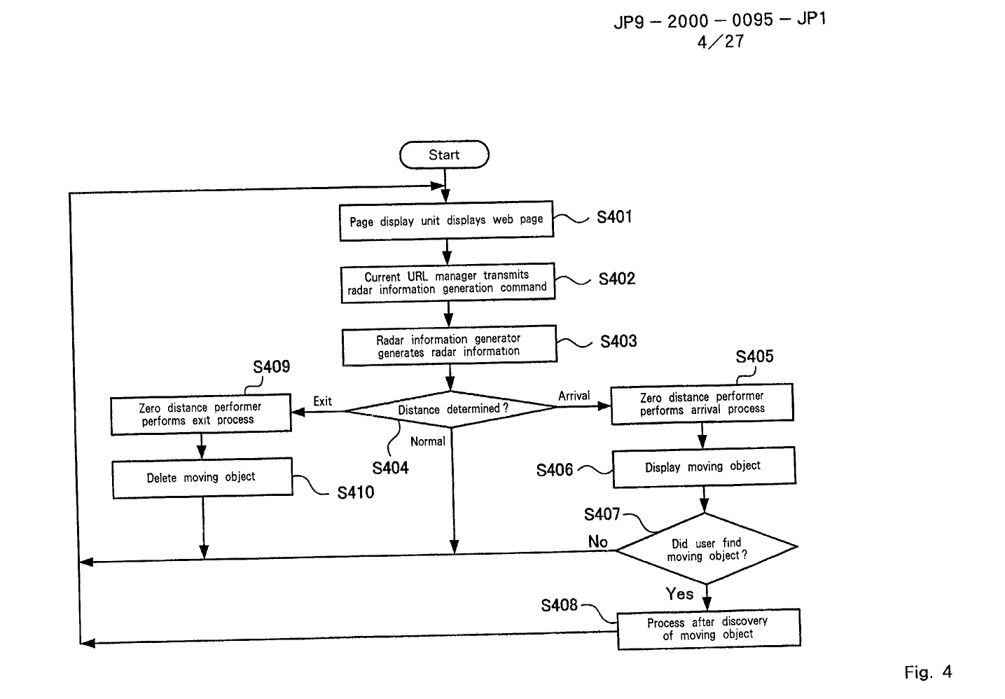

FIG. 4 is a flowchart for explaining the overall processing performed by the user guidance system in FIG. 3.

In FIG. 4, first, the user displays a web page on the page display unit 60 of the user terminal 130 (step 401). This web page belongs to one of the web sites included in the contract site group 210 in FIG. 2. When the web page is displayed on the page display unit 60, the page display unit 60 transmits to the current URL manager 50 the URL of the web page that is displayed. This process is performed each time the web page displayed on the page display unit 60 is updated.

The page display unit 60 is connected, via the zero distance performer 30, to the site server 120 in the contract site group 210.

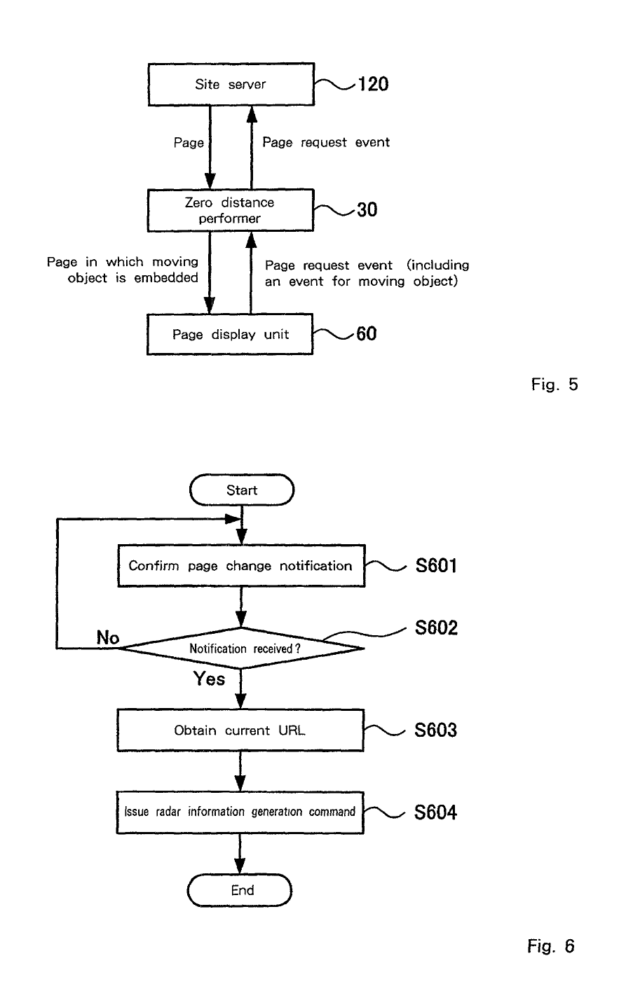

FIG. 5 is a diagram for explaining the connection of the page display unit 60 and the site server 120.

In FIG. 5, a page request event, which is issued by the page display unit 60, is transmitted via the zero distance performer 30 to the site server 120, and the requested web page is returned by the site server 120, via the zero distance performer 30, to the page display unit 60. When the moving object 220 is present at the web page displayed on the page display unit 60, i.e., the web page browsed by the user, the moving object 220 is added to the web page returned by the site server 120 when it is relayed by the zero distance performer 30. When the moving object 220 is not present at the web page displayed on the page display unit 60, the pertinent web page is passed through the zero distance performer 30, without any process being performed therefor.

When the moving object 220 is present at the web page displayed on the page display unit 60, and when the user finds the moving object 220 and clicks on it, this event is accepted by the zero distance performer 30.

Following this, the current URL manager 50 transmits, to the radar information generator 20, both the URL of the web page that is currently displayed on the page display unit 60 and is browsed by the user, and a command for the generation of radar information concerning the current location of the moving object 220 (step 402).

Then, based on the URL received with the command, the radar information generator 20 generates radar information for generation of the radar information (step 403). Subsequently, the obtained radar information is transmitted to the user terminal 130 and is reflected by the screen for the radar 230 displayed by the radar display unit 40. Further, the radar information generator 20 transmits the process to the zero distance performer 30, in accordance with the distance, which is calculated upon the generation of the radar information, between the web page that the user is browsing and the web page whereat the moving object 220 is located (step 404).

The zero distance performer 30 performs different processes when the web page that is currently being browsed is the same as the web page whereat the moving object 220 is located (when the user has reached the web page whereat the moving object 220 is located) and when the web page whereat the moving object 220 is located is moved to another web page (the user exits the current web page).

As will be described later, when the user has reached the web page whereat the moving object 220 is located, the radar information generator 20 ascertains the veracity of that effect and transmits a notification attesting to that effect to the zero distance performer 30 (step 405). Upon the receipt of this notification, the zero distance performer 30 displays the moving object 220 on the page display unit 60 of the user terminal 130 (step 406).

When the user finds the moving object 220 on the display, he or she performs a specific operation to transmit a notice to that effect to the zero distance performer 30. Then, as the process to be performed following the location of the moving object 220, the zero distance performer 30 displays a specific dialogue on the user terminal 130 and requests the entry by the user of information concerning the pertinent user. The information entered in accordance with this dialogue is transmitted by the zero distance performer 30 to the moving object manager 10, which thereafter manages the information (steps 407 and 408).

When the user can not find the moving object 220, even though he or she is browsing the web page whereat the moving object 220 is located, and when the user thereafter moves to another web page, it means that the user has exited the web page whereat the moving object 220 is located (steps 407 and 401 to 404). In this case, as will be described later, the radar information generator 20 ascertains that the user has exited the web page whereat the moving object 220 is located and transmits a notification to that effect to the zero distance performer 30 (step 409). Upon the receipt of this notification, the zero distance performer 30 deletes the moving object 220 displayed on the web page at step 406 (step 410).

It should be noted that in this embodiment data (hereinafter referred to as content data) concerning the contents of the moving object 220 are supposed to be stored in the main server 110, which includes the moving object manager 10. A linking object for accessing the content data of the moving object 220 is displayed on the web page of the web site included in the contract site group 210. That is, when the user clicks on a linking object that appears at the contract site group 210, the moving object 220, which is managed by the moving object manager 10, is activated. Therefore, in the following explanation, when the linking object is present at a predetermined web page, i.e., when a link to the content data of the moving object 220 is set in the predetermined web page, it is assumed that the moving object 220 is located at the web page.

Naturally, unlike the embodiment wherein only the linking object for the content data of the moving object 220 is moved, the substance of the moving object 220, to include the content data, may be moved. In this case, the content data for the moving object 220 are transferred and distributed among the site servers 120 of the web sites included in the contract site group 210. Thus, the moving object manager 10 of the main server 110 must constantly communicate with the site server 120, and must likewise be notified of the location of the moving object 220 and the search status of the user.

The processes performed by the respective functional blocks will now be descried in detail.

FIG. 6 is a flowchart for explaining the processing performed by the current URL manager 50 at step 402 in FIG. 4.

In FIG. 6, first, the current URL manager 50 receives, from the page display unit 60, a web page change notification (steps 601 and 602), and obtains from the notification the URL of a web page that is newly being browsed (step 603). Then, the current URL manager 50 issues a command to the radar information generator 20 for the generation of radar information (step 604).

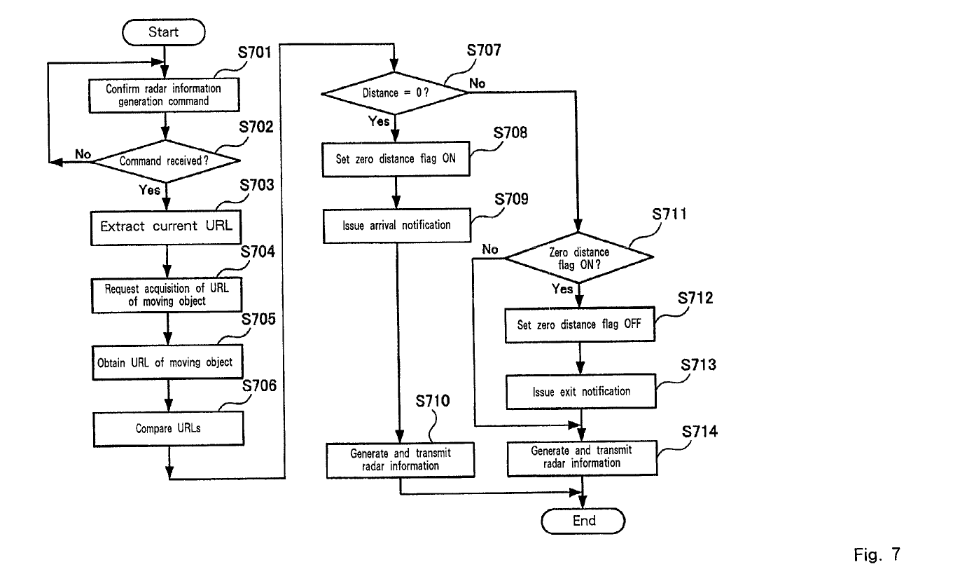

FIG. 7 is a flowchart for explaining the processing performed by the radar information generator 20 at steps 403 and 404 in FIG. 4.

In FIG. 7, first, the radar information generator 20 receives the radar information generation command from the current URL manager 50 (steps 701 and 702), and extracts, from that command, the URL of a new web page that is currently being browsed (step 703).

Then, the radar information generator 20 issues a request to the moving object manager 10 (step 704) for the URL of the moving object 220, and obtains (step 705) the URL of the moving object 220. Sequentially, the radar information generator 20 compares the URL of the current web page obtained at step 703 with the URL of the moving object 220 obtained at step 705, and ascertains the distance between them (step 706) As is described above, since in this embodiment the content data of the moving object 220 is stored in the main server 110, and since the linking object for the content data of the moving object 220 travels to the individual members of the contract site group 210, the URL of the web page for which the link is set is used as the URL of the moving object 220. How the distance between the two URLs is defined will be described later.

When the distance between the two URLs obtained at step 706 is zero, the radar information generator 20 sets to ON a zero distance flag, which is an internal flag provided in order to identify whether the moving object 220 is located at the currently browsed web page (steps 707 and 708). Then, the radar information generator 20 transmits, to the zero distance performer 30, a notification indicating that the moving object 220 is located at the web page that is currently being browsed (step 709). After the transmission of the notification, the radar information generator 20 generates radar information indicating that the moving object 220 is located at the web page that is currently being browsed, and transmits the radar information to the user terminal 130 (step 710).

When the distance between the two URLs is not zero, the radar information generator 20 determines whether the zero distance flag is ON, and if the flag is ON, sets it to OFF (steps 711 and 712). Since because the zero distance flag is ON it is ascertained that the user moved from the web page whereat the moving object 220 is located to another web page, the radar information generator 20 transmits, to the zero distance performer 30, a notification indicating that the user exited the web page whereat the moving object 220 is located (step 713).

When the zero distance flag is OFF, or after the exit notification has been issued, the radar information generator 20 generates radar information based on the distance between the URL of the web page that is currently being browsed and the URL whereat the moving object 220 is located, and transmits the radar information to the user terminal 130 (step 714).

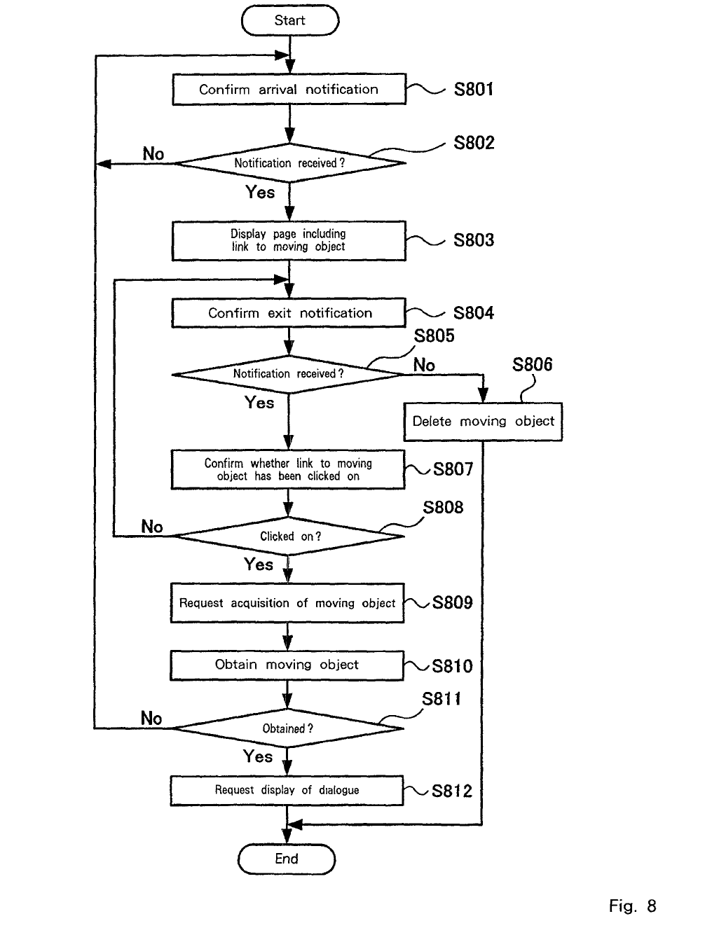

FIG. 8 is a flowchart for explaining the processing performed by the zero distance performer 30 at steps 405, 406, 409 and 410 in FIG. 4.

In FIG. 8, when the zero distance performer 30 receives the arrival notification from the radar information generator 20 (steps 801 and 802), it is ascertained that the user has reached the web page whereat the moving object 220 is located. Thus, the zero distance performer 30 adds to the web page the link with the moving object 220, and transmits the resultant web page to the page display unit 60 of the user terminal 130. As a result, the web page, to include the link with the moving object 220, is displayed on the page display unit 60 (step 803). Specifically, for example, an icon for a link to the moving object 220 can be displayed on the web page.

The above processing corresponds to the arrival notification process at step 405 and the display process at step 406.

After the moving object 220 has been displayed, and when exit notification has been received from the radar information generator 20 (step 804), the zero distance performer 30 ascertains that the user has exited the web page whereat the moving object 220 is located. Thus, the zero distance performer 30 deletes, from the web page, the link with the moving object 220 displayed at step 803 (steps 805 and 806). This processing corresponds to the exit notification process at step 409 and the deletion process at step 410 in FIG. 4.

Further, after the moving object 220 has been displayed, and when the zero distance performer 30 has received, from the page display unit 60, an event indicating that the link with the moving object 220 has been clicked on, instead of the exit notification output by the radar information generator 20 (steps 807 and 808), the zero distance performer 30 issues a request to the moving object manager 10 to obtain the content data of the moving object 220 (step 809). Upon the receipt of this request, the moving object manager 10 transmits the content data of the moving object 220 (step 810).

When it is confirmed that the content data of the moving object 220 has been obtained, the zero distance performer 30, to display a dialogue so as to perform the process following the location of the moving object 220, issues a request to the user terminal 130 (steps 811 and 812). Upon the receipt of this request, the user terminal 130 displays a predetermined dialogue, and accepts the entry from the user. While specific data to be entered varies depending on how the user guidance system of the invention that uses the moving object 220 is employed, ID information, for example, for identifying the user who located the moving object 220 is entered. The data entered in the dialogue are transmitted, via the zero distance performer 30, to the moving object manager 10, which thereafter manages the data.

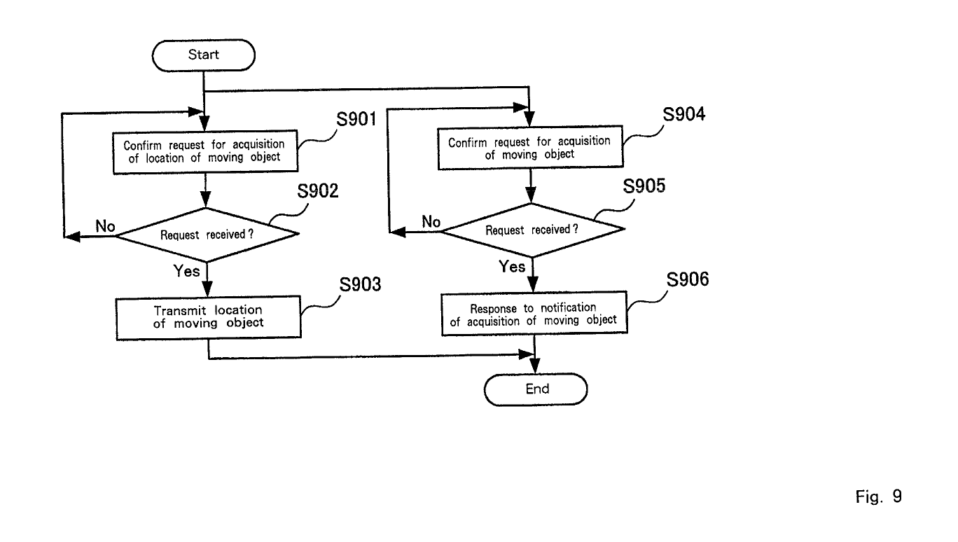

FIG. 9 is a flowchart for explaining the processing performed by the moving object manager 10. In FIG. 9, the moving object manager 10 receives, from the radar information generator 20, a request for obtaining the URL of the moving object 220, and receives, from the zero distance performer 30, a request for obtaining the moving object 220. When the request for obtaining the URL of the moving object 220 is received from the radar information generator 20 (steps 901 and 902), in response the moving object manager 10 transmits the URL of the moving object 220 to the radar information generator 20, which is the request transmission source (step 903).

When a request to obtain the moving object 220 is received from the zero distance performer 30 (steps 904 and 905), the moving object manager 10 transmits a response to the request and the content data of the moving object 220 to the zero distance performer 30, which is the request transmission source (step 906).

The request issued to obtain the moving object 220 is accepted in parallel to the process performed by the user terminal 130: the accessing of the web page of the contract site group 210. Therefore, when the link with the moving object 220 is clicked on, multiple requests for the moving object 220 may be issued at the same time. In this case, the moving object manager 10 must exercise exclusive control that regards only a specific user as the one who had obtained the moving object 220 and that eliminates all the other users. Specifically, the first user to find the moving object 220 is detected, and a message, “the moving object has been obtained”, is transmitted to the user (acquisition response). The acquisition response includes information (an ID or contents) concerning the moving object 220. Further, a message “the moving object has been acquired by another user” is transmitted to the other users (acquisition failure response). In this embodiment, the first user who finds the moving object 220 is regarded as the person who has obtained the moving object 220; however, a specific user determined by another arbitrary reference may be regarded as the person who has obtained the moving object 220.

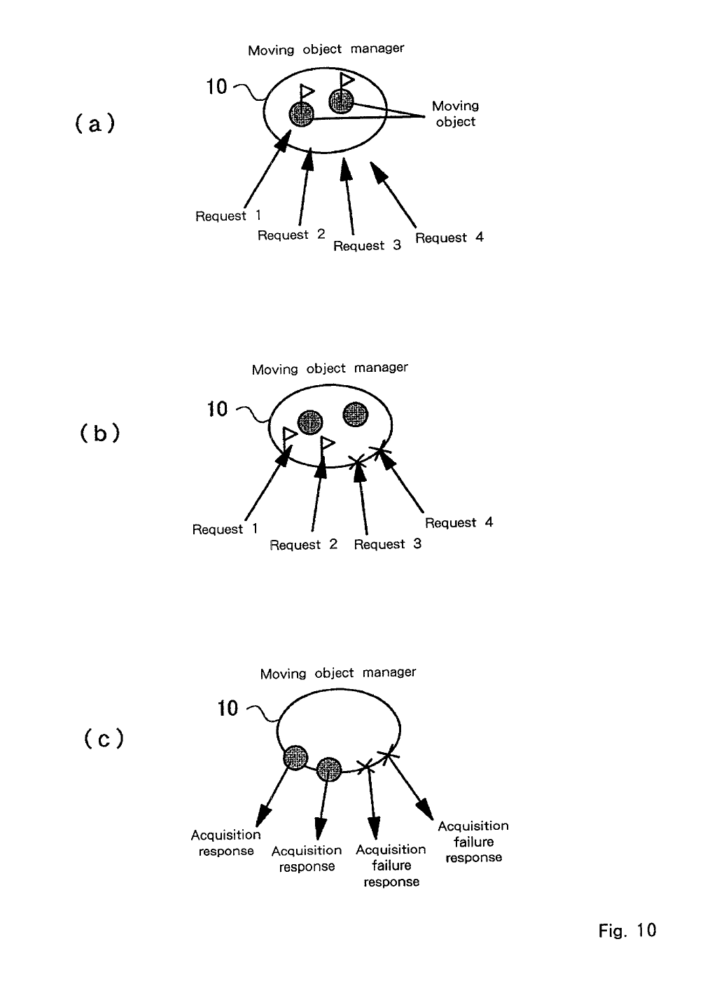

FIGS. 10A to 10C are diagrams for explaining the process performed by the moving object manager 10 when four acquisition requests for two moving objects 220 are issued at the same time. As is shown in FIGS. 10A and 10B, of four acquisition requests 1 to 4, moving objects 220 can be obtained for requests 1 and 2. Thus, as is shown in FIG. 10C, an acquisition response is transmitted to the user terminals 130 that issued the requests 1 and 2, and an acquisition failure response is transmitted to the user terminals 130 that issued the requests 3 and 4.

Further, although not shown, the moving object manager 10 accepts, from the zero distance performer 30, the data that are entered by using a predetermined dialogue during the process performed by the zero distance performer 30, following the finding of the moving object 220, and manages information concerning the user who has obtained the moving object 220.

An explanation will now be given for the radar 230 displayed at the user terminal 130 by the radar display unit 40. The radar 230 submits the distance to the currently browsed web page to the target moving object 220 by using an expression form that a user can visually identify. The distance between the current web page and the moving object 220 (distance between the URL of the web page that the user is browsing and the URL of the web page whereat the moving object 220 is located) is not a physical distance, but is a concept whereby the ease with which a transfer can be effected from the web page that is presently being browsed to the web page at which the moving object 220 is present is represented by a numerical value. Various methods can be used to define this distance. An explanation will now be given for the definitions used for several distances and the method for calculating the distances.

First, the definition of the distance between the URLs, for which the URL structure is used, will be described. Since a site name and a file name are described as a URL in accordance with the hierarchical structure of the storage locations of files, the distance can be defined based on the hierarchical structure as indicated by the URLs.

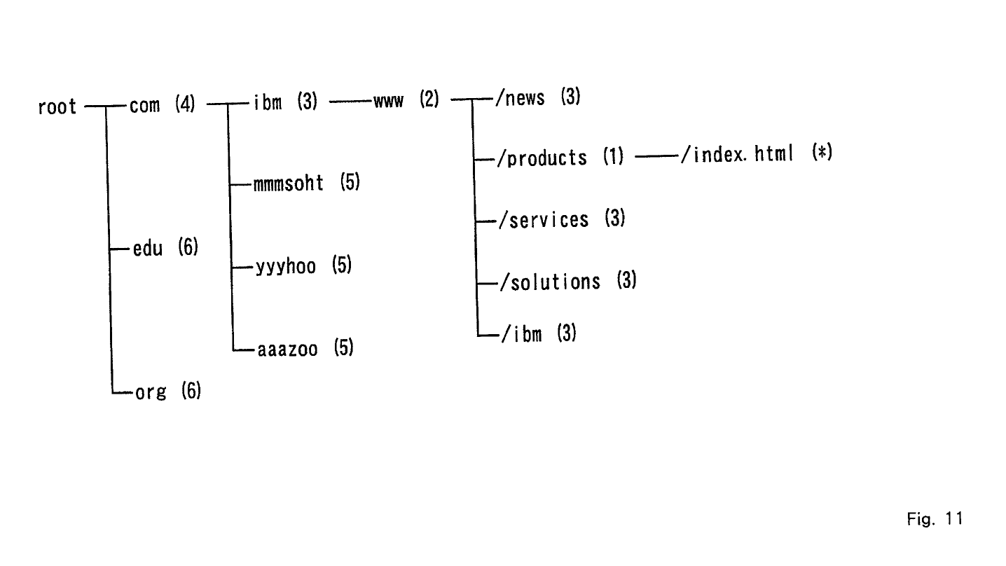

FIG. 11 is a diagram for explaining the distance between defined URLs by using the structures of the URLs. In FIG. 11, the hierarchical structure of the storage locations of files indicated by the URLs is expressed as a tree structure. In FIG. 11, the URL with an asterisk (*) is the one whereat the moving object 220 is located. The numbers added to nodes indicate the distances to the moving object 220. For example, since “com.ibm.www/products” can be reached by tracking one branch from “com.ibm.www/products/index.html”, the distance is “1”. Similarly, since “com.ibm.www” can be reached by tracking two branches, the distance is “2”. Further, since “com.ibm.www/news” and “com.ibm.www/services”, which are at the same level as “com.ibm.www/products”, can be reached by tracking three branches, the distance is “3”.

An explanation will now be given for the definition of the distance to the URLs using the conceptual hierarchical structure of a web site. The distance can be defined by using the sorting of web sites into categories that employ a search engine.

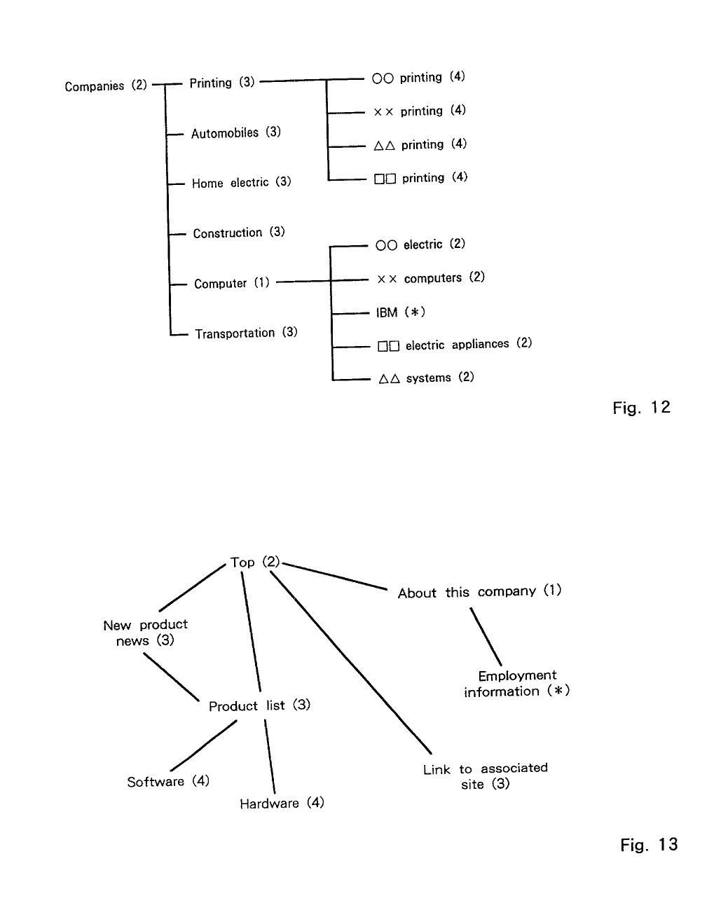

FIG. 12 is a diagram for explaining the distances between URLs that are defined by using the conceptual hierarchical structure, in which the sorting of web sites is represented by categories. In FIG. 12, the hierarchical structure of the categories is expressed as a tree structure. In FIG. 12, the URL with an asterisk (*) is the one whereat, the moving object 220 is located. The numbers added to nodes represent the distances from the moving object 220. For example, since the category “computers” of “companies” can be reached by tracking one branch from “IBM” that is sorted into “computers”, the distance is “1”. Similarly, since “∘∘ Electric” and “×× Computer”, which are at the same level as “IBM”, can be reached by tracking two branches, the distance is “2”. Further, since “ΔΔ Printing” of category “Printing” can be reached by tracking four branches, the distance is “4”.

An explanation will now be given for the definition of the distance between the URLs based on the connection relationship of the hyperlinks of the web pages. The user terminal 130 that is browsing a predetermined web page can jump (move) to another web page along a hyperlink that is set in the current web page. Therefore, the number of jumps required for moving from the current web page to the web page whereat the moving object 220 is located can be defined as the distance between those web pages.

FIG. 13 is a diagram for explaining the distances between the URLs defined by using the hyperlinks of the web pages at a predetermine site. In FIG. 13, the connection relationship of the hyperlinks of multiple web pages is shown. In FIG. 13, the URL with an asterisk (*) is the one whereat the moving object 220 is located. The numbers added to nodes indicate distances to the moving object 220. Since the web page, “about this company”, can be reached with one jump from web page “employment information”, the distance is “1”. Similarly, since “new product News” and “product list” can be reached by three jumps, the distance is “3”. Further, since three jumps are required to move to another associated site, the distance to web page “employment information” is obtained by adding three to the number of jumps that is required to reach this site from the associated site shown in FIG. 13.

In addition to the structural information, such as the URL structure, the sorting of web pages and the connection relationship of the web pages, the descriptions of the URLs can be compared to define the distance between the URL of a predetermined web page and the URL whereat the moving object 220 is located. For example, the number of different characters between two URLs can be defined as the distance between the two. That is, when

(1) http://www.ibm.com/news/index.html and

(2) http://www.ibm.co.jp/news/index.html

are compared, three characters are different between “com” in (1) and “co.jp” in (2). Thus, the distance between the URLs can be defined as “3”. Further, the distance can be set in accordance with how many specific keywords (character strings) are included in a URL. In addition, in accordance with the physical connections of a network, the response time for the network to the target site or the number of computers that pass through the target site, may be employed.

An explanation will now be given for the expression form of the radar 230 that is generated based on the distance between the URLs defined using these methods.

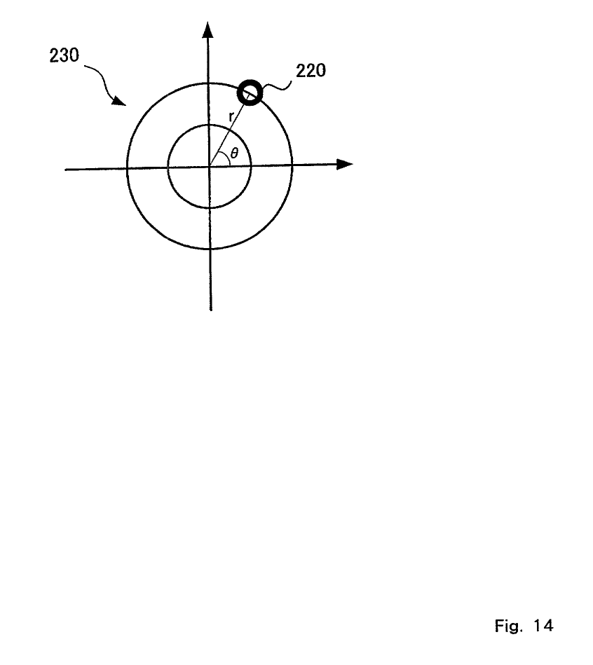

FIG. 14 is a diagram showing an example for the radar 230. In the radar 230, a polar coordinate system is employed to schematically display the position of the moving object 220 relative to a web page that is currently being browsed. That is, with the current web page acting as the origin, the position of the moving object 220 is represented by the parameters (r, θ). The parameter r indicates the distance between the current web page and the moving object 220, and the parameter θ is set in accordance with the tastes of the user and the type of web site whereat the moving object 220 is present. When the parameters are actually used, the parameter θ need not be specifically set. That is, the coordinate system is divided into several fan-shaped regions that are allocated in accordance with, for example, the hobbies of the users, and then, a mark representing the moving object 220 is displayed in an appropriate region in accordance with the type of web site or web page whereat the moving object 220 is located.

Furthermore, instead of displaying the radar chart employing the polar coordinate system, simply a numerical value representing the distance between the currently browsed web page and the moving object 220 may be displayed, or a graph may be displayed that represents the locus of a change in the distance to the moving object 220 based on the browsing history of the web page.

Further, a list of web sites that store the web page whereat the moving object 220 is located may be displayed. In this list, display colors used for list elements may be changed in accordance with the distance between the current web page and the list element that is a web site, so as to apprise a user of the distance. When a user is browsing the web page of a web site that is not one of the members of the contract site group 210 whereat the moving object 220 may be located, the distance between the current web page and the moving object 220 may be quite large, depending on the distance definition method that is used. Therefore, in such a case the radar may be displayed using the list format, and later, after the user has moved to the web page of a contract site group 210 member or to the web page whereat the moving object 220 is actually located, the radar chart in FIG. 14 may be employed in conjunction with numerical values or a graph.

Modes for the network system for carrying out the embodiment will now be described.

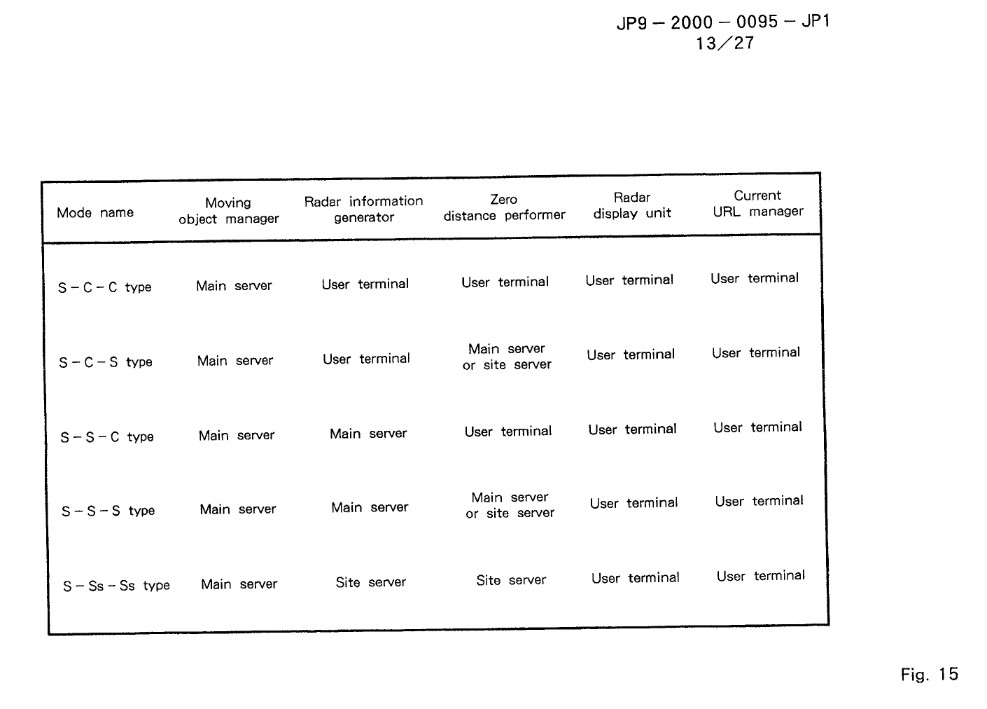

FIG. 15 is a diagram showing a list of modes for the network system. As is described above, in this embodiment, the moving object manager 10 is provided for the main server 110, and the radar display unit 40, the current URL manager 50 and the page display unit 60 are provided for the user terminal 130. Therefore, depending on whether the radar information generator 20 and the zero distance performer 30 are provided, the network system can be sorted into several modes.

In FIG. 15, in accordance with the embodiment, five modes are shown for the network system: an S-C-C type, whereat both the radar information generator 20 and the zero distance performer 30 are provided for the user terminal 130; an S-C-S type, whereat the radar information generator 20 is provided for the user terminal 130 and the zero distance performer 30 is provided for the main server 110 or the site server 120; an S-S-C type, whereat the radar information generator 20 is provided for the main server 110 and the zero distance performer 30 is provided for the user terminal 130; an S-S-S type, whereat the radar information generator 20 is provided for the main server 110 and the zero distance performer 30 is provided for the main server 110 or the site server 120; and an S-Ss-Ss type, whereat both the radar information generator 20 and the zero distance performers 30 are-provided for the site server 120.

According to the S-C-C type mode in FIG. 15, of the operations performed for the above embodiment, the user terminal 130 is in charge of (1) the transmission of a radar information generation command from the current URL manager 50 to the radar information generator 20; (2) the transmission of radar information from the radar information generator 20 to the radar display unit 40; (3) the exchange of data by the page display unit 60 and the zero distance performer 30 when the page display unit 60 obtains a web page or issues an event in response to the instruction for the web page, or when the page display unit 60 generates a dialogue and permits the addition of a data entry to the dialogue; and (4) the transmission of an arrival notification or an exit notification by the radar information generator 20 to the zero distance performer 30. And in addition, when the moving object 220 is found, (5) the exchange of data by the zero distance performer 30 and the moving object manager 10 is effected through data communication between the user terminal 130, which includes the zero distance performer 30, and the main server 110, which includes the moving object manager 10.

In this mode, the radar information generator 20 and the zero distance performer 30 may be provided as functions of the web browser for the user terminal 130 by the use of plug-ins, for example, or they may be provided as application programs.

Next, according to the S-C-S type mode wherein the zero distance performer 30 is provided for the main server 110, the user terminal 130 is in charge of (1) the transmission of a radar information generation command by the current URL manager 50 to the radar information generator 20; and (2) the transmission of radar information by the radar information generator 20 to the radar display unit 40. Further, (3) the exchange of data by the page display unit 60 and the zero distance performer 30 when the page display unit 60 obtains a web page or issues an event in response to the instruction for the web page, or when the page display unit 60 generates a dialogue and permits the addition of data to the dialogue; and (4) the transmission by the radar information generator 20 of an arrival notification or an exit notification to the zero distance performer 30 is effected by data communication between the user terminal 130, which includes the page display unit 60 and the radar information generator 20, and the main server 110, which includes the zero distance performer 30. In addition, the main server 110 is in charge of (5) the exchange of data by the zero distance performer 30 and the moving object manager 10 when the moving object 220 is found. In this mode, the radar information generator 20 may be provided as a function of the web browser for the user terminal 130 by the use of a plug-in, for example, or it may be provided as an application program.

According to the S-C-S type mode when the zero distance performer 30 is provided for the site server 120, there are the following differences from when the zero distance performer 30 is provided for the main server 110: (3) the exchange of data by the page display unit 60 and the zero distance performer 30 when the page display unit 60 obtains a web page or issues an event in response to the instruction for the web page, or when the page display unit 60 generates a dialogue and permits the addition of data to the dialogue; and (4) the transmission of an arrival notification or an exit notification by the radar information generator 20 to the zero distance performer 30 are effected by data communication between the user terminal 130 and the site server 120. Further, (5) the exchange of data by the zero distance performer 30 and the moving object manager 10 when the moving object 220 is found is effected by data communication between the site server 120 and the main server 110.

According to the S-S-C type mode, (1) the transmission of a radar information generation command by the current URL manager 50 to the radar information generator 20; (2) the transmission of radar information by the radar information generator 20 to the radar display unit 40; (4) the transmission of an arrival notification or an exit notification by the radar information generator 20 to the zero distance performer 30; and (5) the exchange of data by the zero distance performer 30 and the moving object manager 10 when the moving object 220 is found are effected by data communication between the main server 110, which includes the moving object manager 10 and the radar information generator 20, and the user terminal 130, which includes the zero distance performer 30. In addition, the user terminal 130 is in charge of (3) the exchange of data by the page display unit 60 and the zero distance performer 30 when the page display unit 60 obtains a web page or issues an event in response to the instruction for the web page, or when the page display unit 60 generates a dialogue and permits the addition of data to the dialogue. In this mode, the zero distance performer 30 may be provided as a function of the web browser for the user terminal 130 by the use of a plug-in, for example, or it may be provided as an application program.

According to the S-S-S type mode wherein the zero distance performer 30 is provided for the main server 110, (1) the transmission of a radar information generation command by the current URL manager 50 to the radar information generator 20; (2) the transmission of radar information by the radar information generator 20 to the radar display unit 40; and (3) the exchange of data by the page display unit 60 and the zero distance performer 30 when the page display unit 60 obtains a web page or issues an event in response to the instruction for the web page, or when the page display unit 60 generates a dialogue and permits the addition of data to the dialogue are effected by data communication between the user terminal 130 and the main server 110, which includes the radar information generator 20 and the zero distance performer 30. In addition, the main server 110 is in charge of (4) the transmission of an arrival notification or an exit notification by the radar information generator 20 to the zero distance performer 30; and (5) the exchange of data by the zero distance performer 30 and the moving object manager 10 when the moving object 220 is found.

According to the S-S-S type mode wherein the zero distance performer 30 is provided for the site server 120, there is the following difference from when the zero distance performer 30 is provided for the main server 110: (3) the exchange of data by the page display unit 60 and the zero distance performer 30 when the page display unit 60 obtains a web page or issues an event in response to the instruction for the web page, or when the page display unit 60 generates a dialogue and permits the addition of data to the dialogue is effected by data communication between the user terminal 130 and the site server 120. Further, (4) the transmission of an arrival notification or an exit notification by the radar information generator 20 to the zero distance performer 30; and (5) the exchange of data by the zero distance performer 30 and the moving object manager 10 when the moving object 220 is found are effected by data communication between the site server 120 and the main server 110.

According to the S-Ss-Ss type mode, (1) the transmission of a radar information generation command by the current URL manager 50 to the radar information generator 20; (2) the transmission of radar information by the radar information generator 20 to the radar display unit 40; and (3) the exchange of data by the page display unit 60 and the zero distance performer 30 when the page display unit 60 obtains a web page or issues an event in response to the instruction for the web page, or when the page display unit 60 generates a dialogue and permits the addition of data to the dialogue are effected by data communication between the user terminal 130 and the site server 120, which includes the radar information generator 20 and the zero distance performer 30. In addition, the site server 120 is in charge of (4) the transmission of an arrival notification or an exit notification by the radar information generator 20 to the zero distance performer 30; and (5) the exchange of data by the zero distance performer 30 and the moving object manager 10 when the moving object 220 is found.

As is described above, the S-C-S and the S-S-S type modes each have two arrangements whereby the zero distance performer 30 is provided for the main server 110 and whereby it is provided for the site server 120. The difference between these arrangements will now be described. As is described above, when one moving object 220 is found by multiple users, exclusive control must be exercised in order for a specific user to be regarded as the person who acquired the moving object 220, and to invalidate events by the other users indicating they discovered the moving object 220 (e.g., a clicking event for a link with the moving object 220). When the zero distance performer 30 is present in the main server 110, the main server 110 accepts multiple events for the discovery of the same moving object 220. Therefore, the main server 110 exercises exclusive control for the handling of events by users other than the specific user who is regarded as the person who acquired the moving object 220, and notifies the user terminals 130 of the result. Therefore, a great load is imposed on the main server 110, and there is increased communication traffic.

Whereas, when the zero distance performer 30 is located at the site server 120, immediately after the moving object 220 is found by a specific user, the site server 120 can invalidate discovery events by other users. As a result, after the moving object 220 has been found by one of the users, the site server 120 need only notify the main server 110 of the acquisition of the moving object 220. Therefore, the load imposed on the main server 110 is reduced, as is the communication traffic. However, the program for implementing the zero distance performer 30 must be installed in the site server 120, and a load is also imposed on the web site manager.

As is described above, there are advantages and disadvantages, regardless of whether the zero distance performer 30 is provided for the main server 110 or for the site server 120. Therefore, it is preferable that arrangement of the zero distance performer 30 depend on the system operation type.

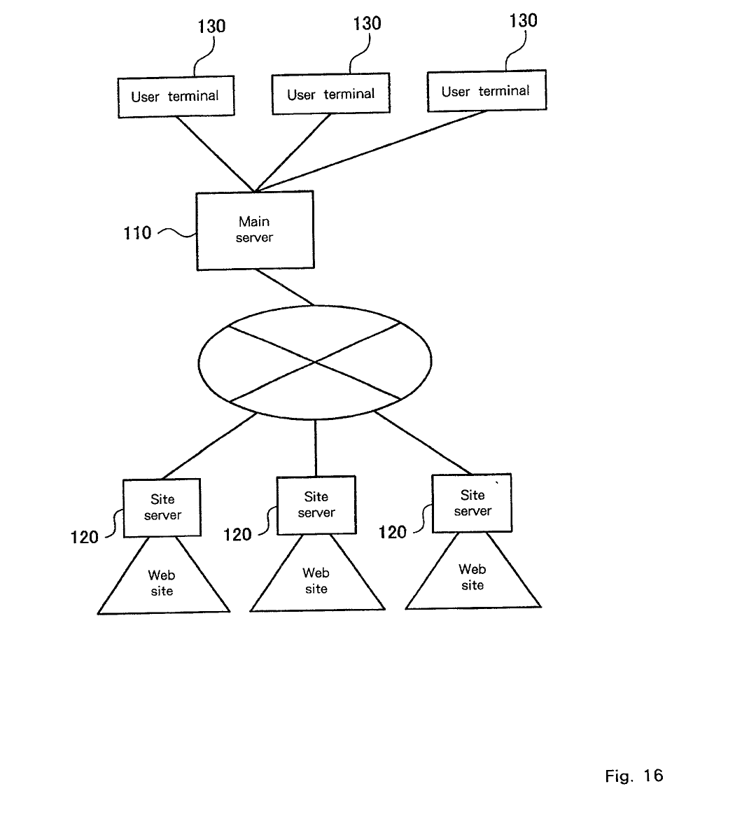

FIGS. 16 to 19 are diagrams showing a network configuration for carrying out the above described network system.

In the configuration in FIG. 16, the zero distance performer 30 is provided for the main server 110 according to the S-C-S or the S-S-S type mode. The user terminals 130 are connected to the network via the main server 110. Therefore, various operations performed by the user terminals 130 for the site servers 120 are managed by the main server 110, and a process, such as the appearance or the deletion of the moving object 220 or the acquisition of the moving object 220 by a user, can be controlled.

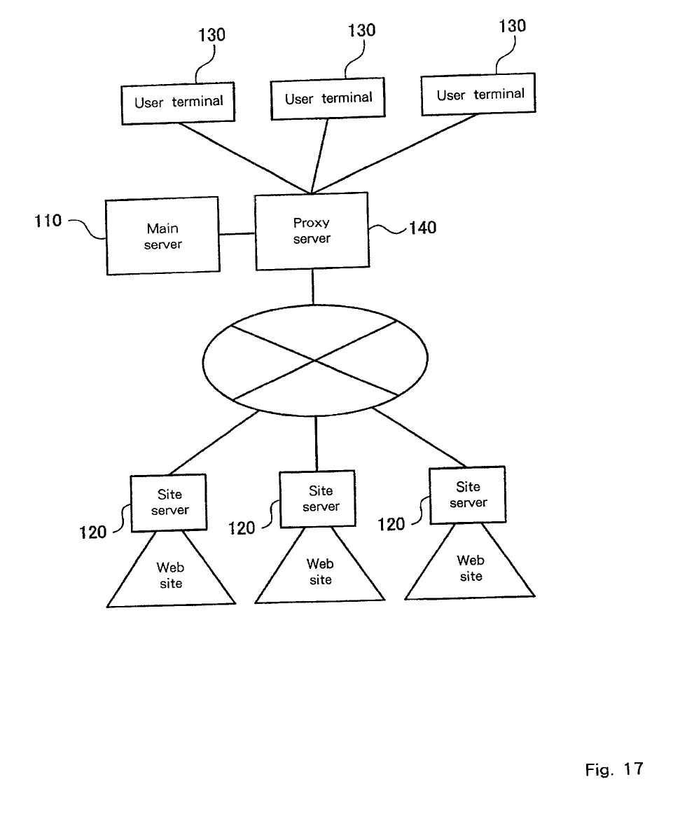

In FIG. 17, another configuration is shown wherein the zero distance performer 30 is provided for the main server 110 according to the S-C-S or the S-S-S type mode. The user terminals 130 are connected to the network via a proxy server 140, and in accordance with various operations performed by the user terminals 130 for the site servers 120, the main server 110 performs a process as needed.

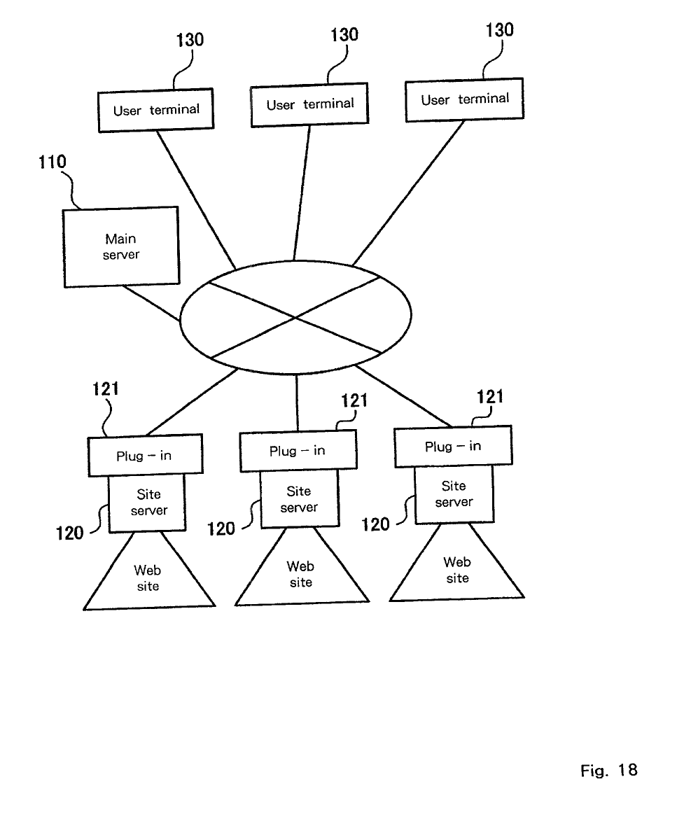

In the configuration in FIG. 18, the zero distance performer 30 is provided for the site server 120 according to the S-C-S, the S-S-S or the S-Ss-Ss type mode. Plug-ins 121 are added to the site servers 120 to provide the zero distance performer 30 function, and therefore, a process, such as the appearance or the deletion of the moving object 220 and the acquisition of the moving object 220 by a user, can be controlled by the site servers 120.

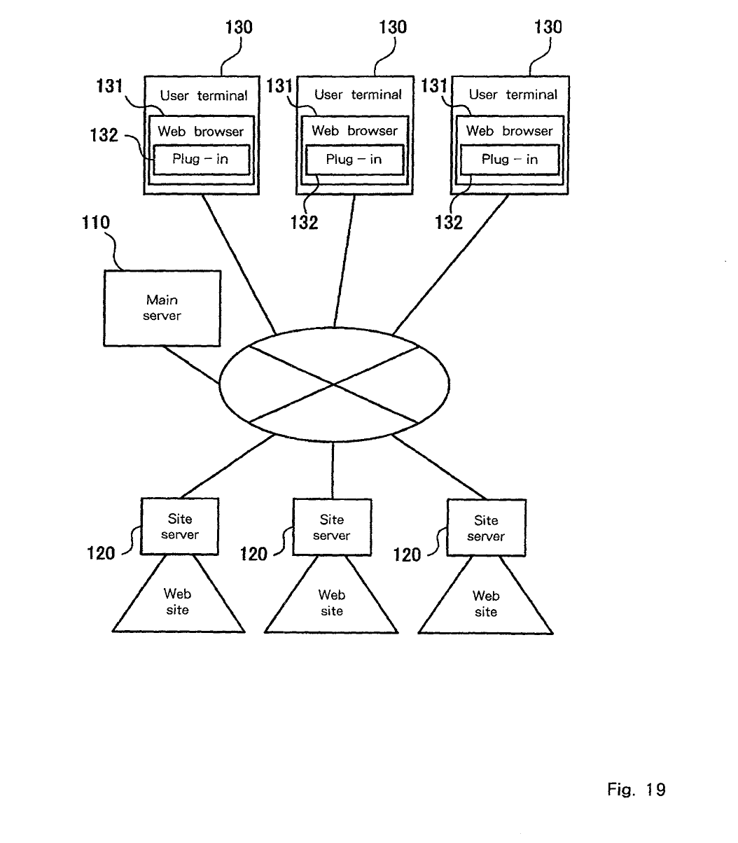

In the configuration in FIG. 19, the zero distance performer 30 is provided for the user terminal 130 according to the S-C-C or the S-S-C type mode. As is shown in FIG. 19, plug-ins 132 are added to web browsers 131 of the user terminals 130 in order to provide the radar information generator 20 and the zero distance performer 30 functions, and therefore, the user terminals 130 control a process, such as the appearance or the deletion of the moving object 220 or the acquisition of the moving object 220 by a user, and transmit only the results to the main server 110. When the network configurations shown in FIGS. 16 to 19 are combined and employed as needed, the user guidance system according to the embodiment can be implemented.

Second Embodiment

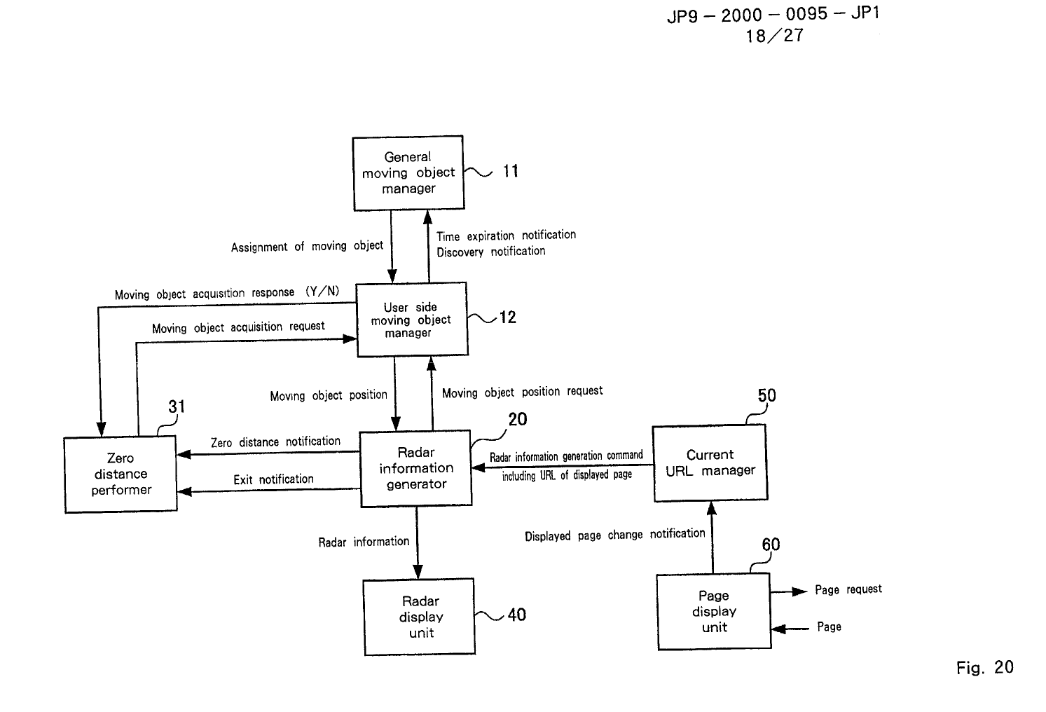

FIG. 20 is a diagram for explaining a user guidance system according to a second embodiment.

In FIG. 20, a general moving object manager 11 manages information, such as the location of a moving object 220 and a search status. For each user terminal 130, a user side moving object manager 12 supports the general moving object manager 11 for the management of the moving object 220. When the user has reached a web page whereat the moving object 220 is located, i.e., when the user is browsing that web page, a zero distance performer 31 displays the moving object 220 on the web page and performs a process when the user finds the moving object 220.

Since a radar information generator 20, a radar display unit 40, a current URL manager 50 and a page display unit 60 are the same as those for the radar information generator 20, the radar display unit 40, the current URL manager 50 and the page display unit 60 in the first embodiment shown in FIG. 3, the same reference numerals are used to denote these components, and no further explanation will be given for them. In the second embodiment, it should be noted that the radar information generator 20 is provided for the user terminal 130.

With this configuration, the general moving object manager 11 is provided for the main server 110. The user side moving object manager 12 is provided for the user terminal 130 of a user who participates in a search event for finding the moving object 220. And the user side moving object manager 12 may be provided as a function of the web browser for the user terminal 130 by the use of a plug-in, for example, or may be provided as an application program.

In this embodiment, the general moving object manager 11 provided for the main server 110 only manages information, such as the location of the moving object 220 and the search status and acquisition status for the moving object 220. The user side moving object manager 12 stores the data for the contents of the moving object 220, and performs the process with the radar information generator 20 that is required for the positional information of the moving object 220 and the process with the zero distance performer 31 that is required for the acquisition of the moving object 220.

As is described above, in this embodiment, data for the contents of the moving object 220 and the positional information are stored by each of the user terminals 130. Thus, when the moving object 220 is found by a predetermined user, the information for the moving object 220, which is managed by the user side moving object manager 12 in each user terminal 130, must be updated (hereinafter, this information is referred to as assigned information, and the provision of the information to the moving object manager 12 is referred to the moving object assignment). Thus, the effective period for the assigned information of the moving object 220 is determined, and when the effective period has expired, the assigned information is abandoned and the moving object 220 is reassigned. When the moving object 220 is found by a specific user, the moving object manager 12 of the user terminal 130 forwards a notification to that effect to the general moving object manager 11. Therefore, when notifications of the discovery of the same moving object 220 are received from the moving object managers 12 of multiple user terminals 130, the general moving object manager 11 assumes and exercises exclusive control.

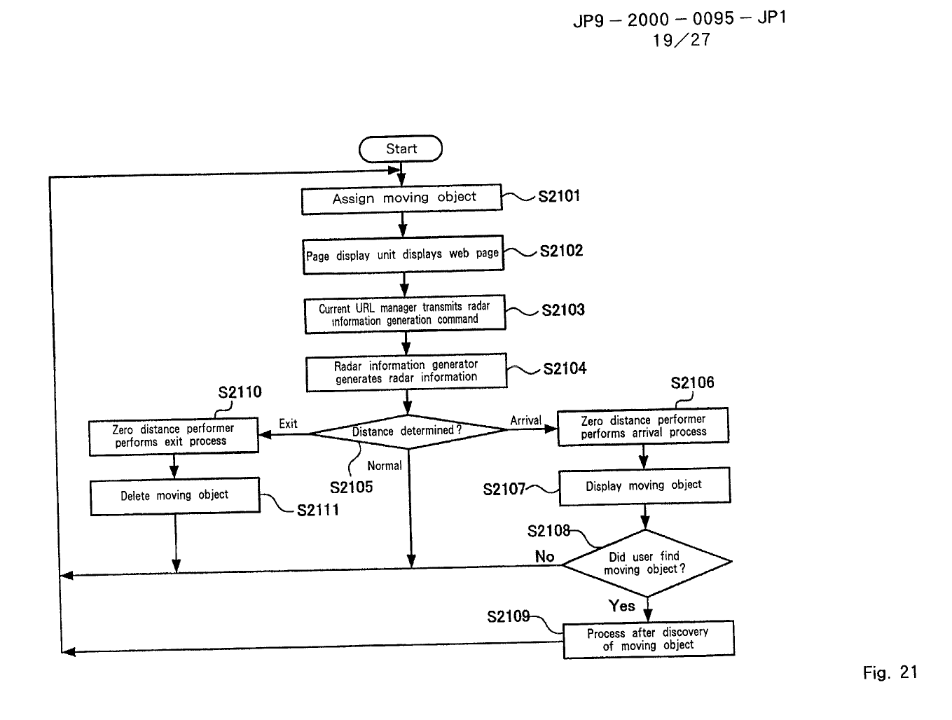

FIG. 21 is a flowchart for explaining the general processing performed by the user guidance system in FIG. 20.

In FIG. 21, first, as the initial setup, the general moving object manager 11 assigns the moving object 220 to the moving object manager 12 of each of the user terminals 130 (step 2101). Thus, the user terminals 130 can obtain a variety of information (radar information and data for contents) concerning the moving object 220.

Then, the web page is displayed on the page display unit 60 of the user terminal 130 (step 2102). This web page is one at a web site that is a member of the contract site group 210 in FIG. 2. When the web page is displayed on the page display unit 60, the page display unit 60 notifies the current URL manager 50 of the URL of the web page on the display.

Next, the current URL manager 50 transmits, to the radar information generator 20, the radar information generation command concerning the current location of the moving object 220, together with the URL of the web page that is currently displayed by the page display unit 60 (step 2103).

The radar information generator 20 generates radar information based on the URL that is received with the radar information generation command (step 2104). Then, the obtained radar information is transmitted to the user terminal 130, and is reflected by the radar 230 displayed by the radar display unit 40. In addition, the radar information generator 20 transmits the process to the zero distance performer 31 in accordance with the distance, which is obtained during the generation of the radar information, between the web page that the user is currently browsing and the web page whereat the moving object 220 is located (step 2105).

When the user exits the web page displayed on the page display unit 60 and reaches the web page whereat the moving object 220 is located, the radar information generator 20 transmits, to the zero distance performer 31, an arrival notification indicating that the user has reached the web page (step 2106). Upon the receipt of this notification, the zero distance performer 31 displays the moving object 220 on the page display unit 60 of the user terminal 130 (step 2107). When the user has found the moving object 220 on the display, he or she performs a predetermined manipulation to transmit notification of the discovery of the moving object 220. In response to this manipulation, the zero distance performer 31 displays a predetermined dialogue on the user terminal 130 requesting that the user enter his or her user information. The information input to the dialogue is transmitted by the zero distance performer 31 to the user side moving object manager 12, and is also transmitted to the general moving object manager 11 (steps 2108 and 2109).

When the user exits the web page whereat the moving object 220 is located (steps 2108 and 2101 to 2105), the radar information generator 20 transmits, to the zero distance performer 31, an exit notification indicating the user has exited the web page (step 2110). Upon the receipt of this notification, the zero distance performer 31 deletes the moving object 220 that is displayed on the web page at step 2107 (step 2111).

When the user has found the moving object 220, or when the user has exited the web page whereat the moving object 220 is located, or when the effective period determined at step 2101 for the assigned information has expired, the moving object 220 is reassigned (step 2101).

A detailed explanation will now be given for the processing performed by the moving object manager 12 and the general moving object manager 11.

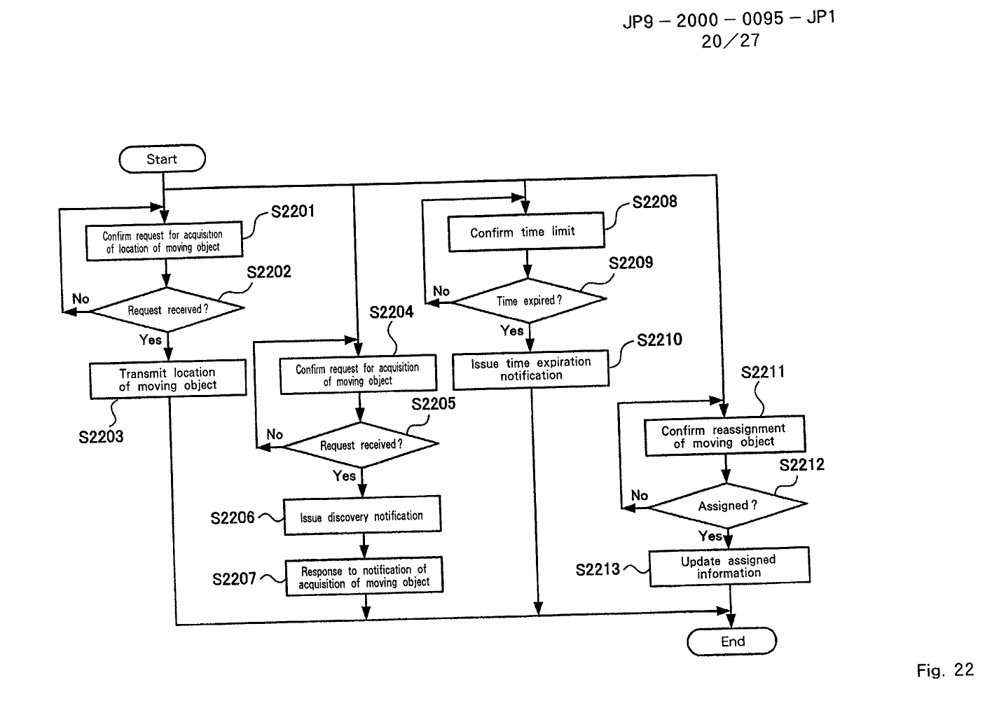

FIG. 22 is a flowchart for explaining the processing performed by the user side moving object manager 12.

In FIG. 22, the moving object manager 12 performs a process for obtaining the URL of the moving object 220, a process for obtaining the moving object 220, a process concerning the effective period for the assigned information for the moving object 220, and a process for the reassignment of the moving object 220. Specifically, when the request to obtain the URL of the moving object 220 is received from the radar information generator 20 (steps 2201 and 2202), the URL of the moving object 220 is returned to the radar information generator 20 of the user terminal 130 that submitted the request (step 2203). When a request to obtain the moving object 220 is received from the zero distance performer 31 (steps 2204 and 2205), the general moving object manager 11 is notified that the moving object 220 was found by a specific user (step 2206). A response to the acquisition request, and the data for the contents of the moving object 220 are returned to the zero distance performer 31, which submitted the request (step 2207). When the effective period for the assigned information of the moving object 220 has expired (steps 2208 and 2209), a notification (time expiration notification) indicating that the effective period for the assigned information has expired is transmitted to the general moving object manager 11 (step 2210). When the general moving object manager 11 reassigns the moving object 220 (steps 2211 and 2212), the assigned information that is stored for the moving object 220 is updated (step 2213).

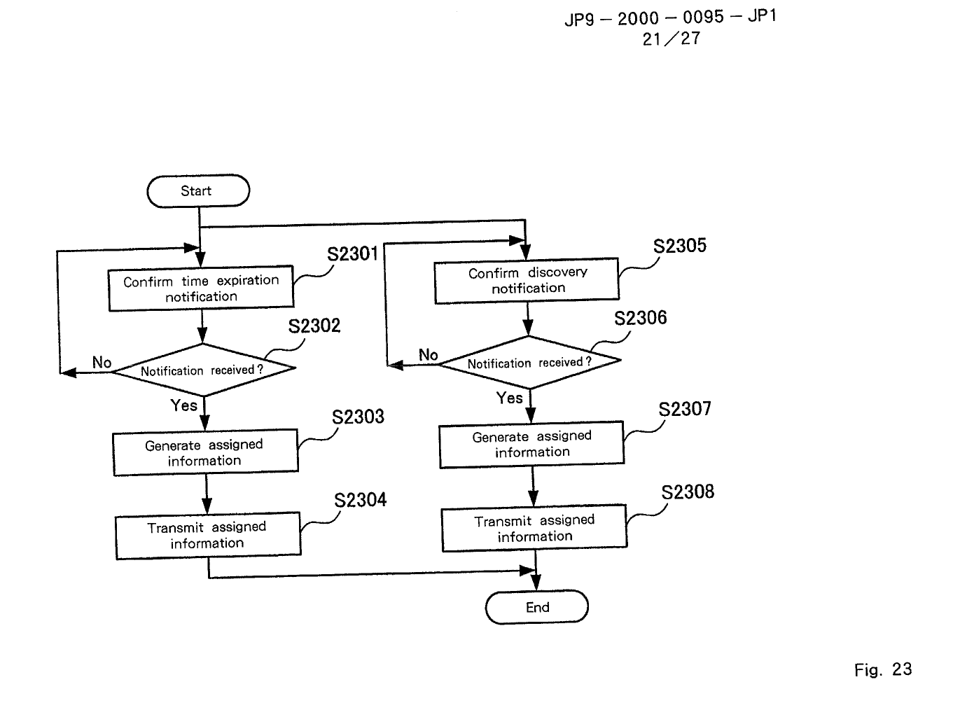

FIG. 23 is a flowchart for explaining the processing performed by the general moving object manager 11.

In FIG. 23, the general moving object manager 11 receives a notification from the user side moving object manager 12, and assigns the moving object 220. Two types of notifications are received from the moving object manager 12: a time expiration notification, indicating the effective period has expired for the assigned information that was previously provided, and a notification indicating the moving object 220 has been found by a user.

Specifically, when the general moving object manager 11 receives the time expiration notification for the assigned information from the moving object manager 12 (steps 2301 and 2302), the general moving object manager 11 regenerates assigned information for the moving object 220 (step 2303). Then, the general moving object manager 11 transmits the assigned information to the moving object manager 12 of the user terminal 130 that issued the time expiration notification (step 2304). In this case, since the purpose of this process is the updating of the old assigned information, the assigned information need not be transmitted to user terminals 130 other than the one that issued the time expiration notification.

When the notification indicating the moving object 220 has been found is received from the user side moving object manager 12 (steps 2305 and 2306), the assigned information concerning the moving object 220 is generated (step 2307). The assigned information is transmitted to the moving object managers 12 of all the user terminals 130 for which assignment of the moving object 220 is performed (step 2308). In this case, since thereafter another user can not obtain the moving object 220, the assigned information is transmitted not only to the user terminal 130 that issued the notification but also to the remaining user terminals 130, as notification that the moving object 220 has been found.

The operations of the page display unit 60, the current URL manager 50, the radar information generator 20, the zero distance performer 31 and the radar display unit 40 are the same as those of the page display unit 60, the current URL manager 50, the radar information generator 20, the zero distance performer 30 and the radar display unit 40 in the first embodiment, and no further explanation for them will be given.

It should be noted, however, that, as is shown in FIG. 20, when the moving object 220 is found, the zero distance performer 31 issues a request for the acquisition of the moving object 220 to the moving object manager 12, and obtains the data for the contents of the moving object 220 from the moving object manager 12.

Modes for the network system according to the second embodiment will now be described.

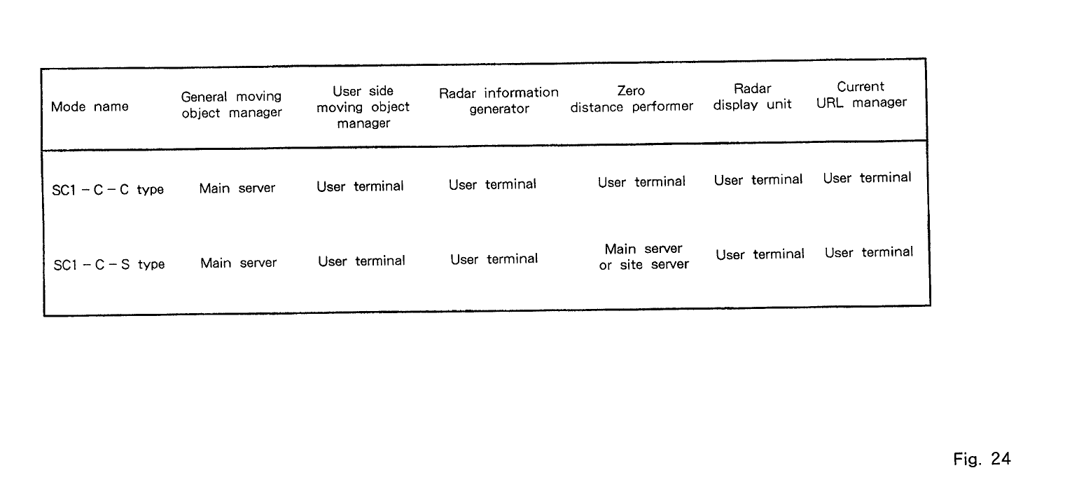

FIG. 24 is a diagram showing a list of the modes for the above described network system. As is described above, in this embodiment, the general moving object manager 11 is provided for the main server 110, the user side moving object manager 12, and the radar information generator 20, the radar display unit 40, the current URL manager 50 and the page display unit 60 are provided for the user terminal 130. Therefore, the network system can be sorted into several modes depending on whether the zero distance performer 31 is provided.

In FIG. 24, according to this embodiment there are two modes for the network system: an SC1-C-C type, wherein the zero distance performer 31 is provided for the user terminal 130, and an SC1-C-S type, wherein the zero distance performer 31 is provided for the main server 110 or the site server 120.

According to the SC1-C-C type in FIG. 24, the user terminal 130 is in charge of (1) the exchange of data by the page display unit 60 and the zero distance performer 31 when the page display unit 60 obtains a web page or issues an event in response to the instruction for the web page, or when the page display unit 60 generates a dialogue and permits the addition of data to the dialogue; (2) the transmission of an arrival notification or an exit notification by the radar information generator 20 to the zero distance performer 31; and (3) the exchange of data by the zero distance performer 31 and the moving object manager 12 when the moving object 220 is found.

According to the SC1-C-S type mode wherein the zero distance performer 31 is provided for the main server 110, the above operations (1) to (3) are effected by data communication between the user terminal 130 and the main server 110, which includes the zero distance performer 31.

According to the SC1-C-S type mode wherein the zero distance performer 31 is provided for the site server 120, the above operations (1) to (3) are effected by data communication between the user terminal 130 and the site server 120, which includes the zero distance performer 31.

When, as in this embodiment, the management of the information concerning the moving object 220 is supported by the user terminal 130, a special moving object 220 for a specific user can appear only at a special site among the members of the contract site group 210.

Third Embodiment

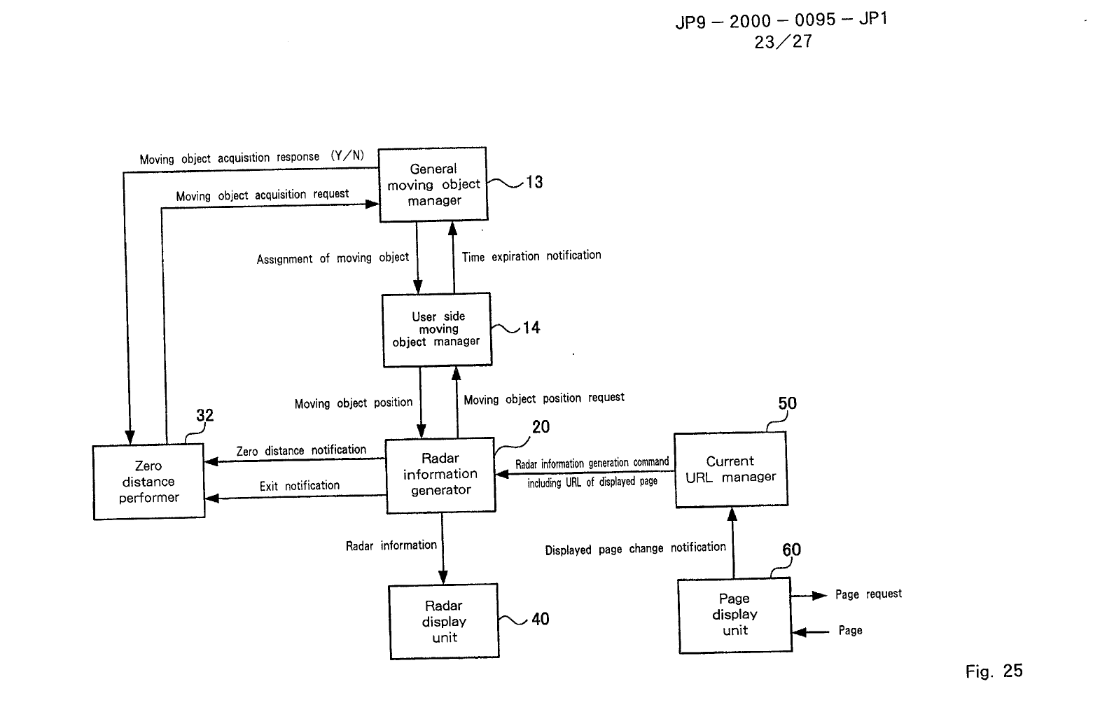

FIG. 25 is a diagram for explaining the configuration of a user guidance system according to a third embodiment.

In FIG. 25, a general moving object manager 13 manages information, such as the position of a moving object 220 and its search status. A user side moving object manager 14 supports, for each user terminal 130, the management of the moving object 220 by the general moving object manager 13. When a user has reached a web page whereat the moving object 220 is located, i.e., when a user is browsing that web page, a zero distance performer 32 displays the moving object 220 on the web page, and performs the process that is required when the user finds the moving object 220.

Since a radar information generator 20, a radar display unit 40, a current URL manager 50 and a page display unit 60 are the same as those for the radar information generator 20, the radar display unit 40, the current URL manager 50 and the page display unit 60 in the first embodiment in FIG. 3, the same reference numerals are used to denote these components and no further explanation will be given for them. It should be noted that in this embodiment the radar information generator 20 is provided for the user terminal 130.

With this configuration, the general moving object manager 13 is provided for the main server 110. The user side moving object manager 14 is provided for the user terminal 130 of a user who participates in an event for the acquisition of the moving object 220. The moving object manager 14 may be provided as a function of the web browser for the user terminal 130 by the use of a plug-in, for example, or it may be provided as an application program. In this embodiment, the general moving object manager 13 provided for the main server 110 manages information, such as the location of the moving object 220 and the search status and the acquisition status for the moving object 220, and stores data for the contents of the moving object 220. The moving object manager 14 performs a process with the radar information generator 20 concerning the positional information of the moving object 220.

As is described above, in this embodiment, the positional information for the moving object 220 is stored in each user terminal 130. Therefore, when the moving object 220 is found by a specific user, the assigned information concerning the moving object 220, which is stored in the moving object manager 14 of each user terminal 130, must be updated. Thus, the effective period for the assigned information for the moving object 220 is determined, and when the effective period has expired, the assigned information is abandoned and the moving object 220 is reassigned.

Since the data for the contents of the moving object 220 are stored in the general moving object manager 13, when the moving object 220 is found by multiple users, the process concerning the acquisition of the moving object 220 is performed by the zero distance performer 32 and the general moving object manager 13. Therefore, the user side moving object manager 14 does not issue to the general moving object manager 13 a notification indicating that the moving object 220 has been found.

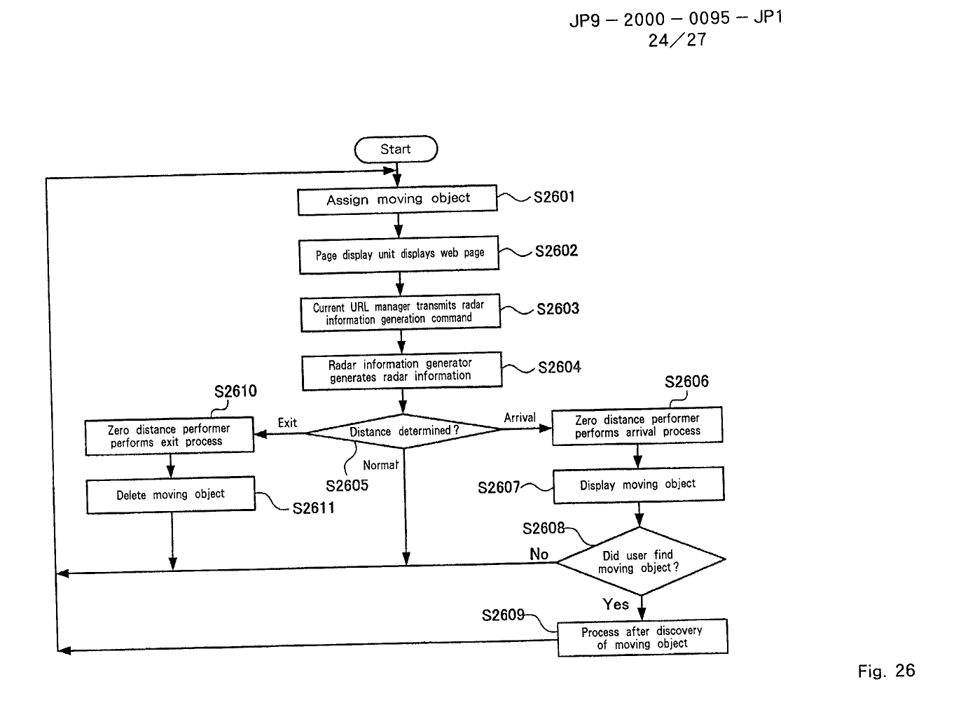

FIG. 26 is a flowchart for explaining the general processing performed by the user guidance system in FIG. 25.

In FIG. 26, first, as the initial setup, the general moving object manager 13 assigns the moving object 220 to the moving object manager 14 of each of the user terminals 130 (step 2601). Thus, the user terminals 130 can obtain a variety of information (radar information and data for contents) concerning the moving object 220.

Then, the web page is displayed on the page display unit 60 of the user terminal 130 (step 2602). This web page is one at a web site that is a member of the contract site group 210 in FIG. 2. When the web page is displayed on the page display unit 60, the page display unit 60 notifies the current URL manager 50 of the URL of the web page on the display.

Next, the current URL manager 50 transmits, to the radar information generator 20, the radar information generation command concerning the current location of the moving object 220, together with the URL of the web page that is currently displayed by the page display unit 60 (step 2603).

The radar information generator 20 generates radar information based on the URL that is received with the radar information generation command (step 2604). Then, the obtained radar information is transmitted to the user terminal 130, and is reflected by the radar 230 displayed by the radar display unit 40.

In addition, the radar information generator 20 transmits the process to the zero distance performer 32 in accordance with the distance, which is obtained during the generation of the radar information, between the web page that the user is currently browsing and the web page whereat the moving object 220 is located (step 2605).

When the user exits the web page displayed on the page display unit 60 and reaches the web page whereat the moving object 220 is located, the radar information generator 20 transmits, to the zero distance performer 32, an arrival notification indicating that the user has reached the web page (step 2606). Upon the receipt of this notification, the zero distance performer 32 displays the moving object 220 on the page display unit 60 of the user terminal 130 (step 2607).

When the user has found the moving object 220 on the display, he or she performs a predetermined manipulation to transmit notification of the discovery of the moving object 220. In response to this manipulation, the zero distance performer 32 displays a predetermined dialogue on the user terminal 130 requesting that the user enter his or her user information. The information input to the dialogue is transmitted by the zero distance performer 32 to the general moving object manager 13, which in turn manages the information (steps 2608 and 2609).

When the user exits the web page whereat the moving object 220 is located (steps 2608 and 2601 to 2605), the radar information generator 20 transmits, to the zero distance performer 32, an exit notification indicating the user has exited the web page (step 2610). Upon the receipt of this notification, the zero distance performer 32 deletes the moving object 220 that is displayed on the web page at step 2607 (step 2611).

When the user has exited the web page whereat the moving object 220 is located, or when the effective period determined at step 2601 for the assigned information has expired, the moving object 220 is reassigned (step 2601).

A detailed explanation will now be given for the processing performed by the moving object manager 14 and the general moving object manager 13.

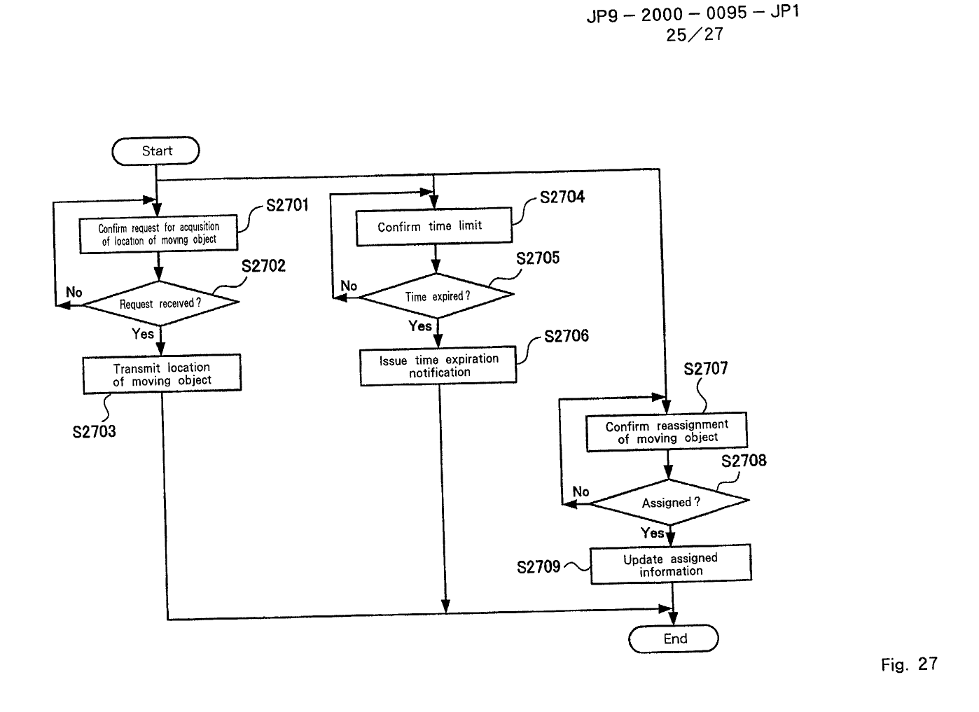

FIG. 27 is a flowchart for explaining the processing performed by the user side moving object manager 14.

In FIG. 27, the moving object manager 14 performs a process for obtaining the URL of the moving object 220, a process concerning the effective period for the assigned information for the moving object 220, and a process for the reassignment of the moving object 220. Specifically, when the request to obtain the URL of the moving object 220 is received from the radar information generator 20 (steps 2701 and 2702), the URL of the moving object 220 is returned to the radar information generator 20 of the user terminal 130 that submitted the request (step 2703). When the effective period for the assigned information of the moving object 220 has expired (steps 2704 and 2705), a time expiration notification indicating that the effective period for the assigned information has expired is transmitted to the general moving object manager 13 (step 2706). When the general moving object manager 13 reassigns the moving object 220 (steps 2707 and 2708), the assigned information that is stored for the moving object 220 is updated (step 2709).

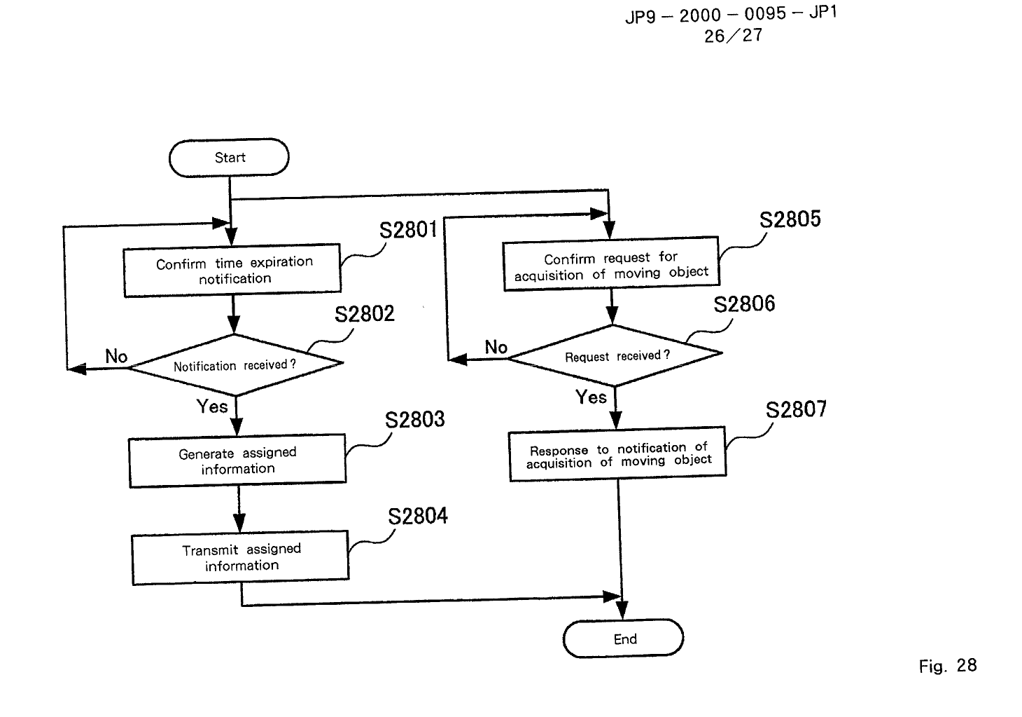

FIG. 28 is a flowchart for explaining the processing performed by the general moving object manager 13.

In FIG. 28, the general moving object manager 13 receives a notification from the user side moving object manager 14 or a request from the zero distance performer 32, and assigns the moving object 220.

Specifically, when the general moving object manager 13 receives the time expiration notification from the moving object manager 14 (steps 2801 and 2802), the general moving object manager 13 regenerates assigned information for the moving object 220 (step 2803). Then, the general moving object manager 13 transmits the assigned information to the moving object manager 14 of the user terminal that issued the time expiration notification (step 2804). In this case, since the purpose of this process is the updating of the old assigned information, the assigned information need not be transmitted to user terminals 130 other than the one that issued the time expiration notification.

When a request for obtaining the moving object 220 is received from the zero distance performer 32 (steps 2805 and 2806), a response to the acquisition request and the data for the contents of the moving object 220 are returned to the zero distance performer 32, which submitted the request (step 2807). In this case, since the moving object 220 that was found can not be acquired by the other users, an acquisition failure signal is transmitted as a response to other requests for the acquisition of the moving object 220.

The operations of the page display unit 60, the current URL manager 50, the radar information generator 20, the zero distance performer 32 and the radar display unit 40 are the same as those of the page display unit 60, the current URL manager 50, the radar information generator 20, the zero distance performer 30 and the radar display unit 40 in the first embodiment, and no further explanation for them will be given.

It should be noted, however, that, as is shown in FIG. 25, when the moving object 220 is found, the zero distance performer 32 issues a request for the acquisition of the moving object 220 to the general moving object manager 13, and obtains the data for the contents of the moving object 220 from the general moving object manager 13.

Modes for the network system according to the second embodiment will now be described.

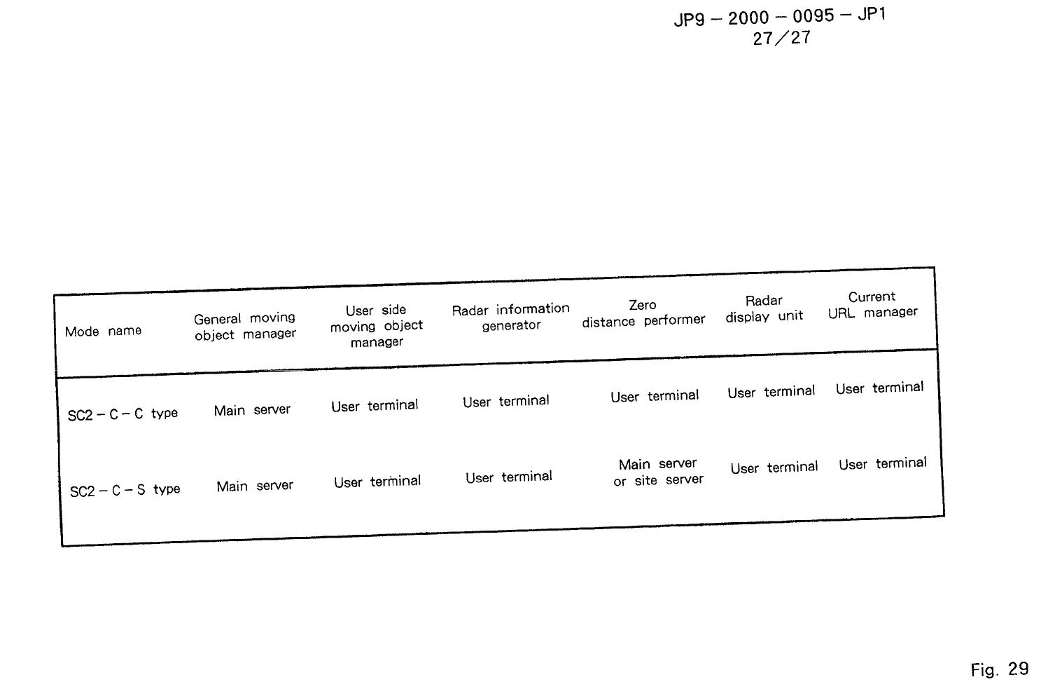

FIG. 29 is a diagram showing a list of the modes for the above described network system. As is described above, in this embodiment, the general moving object manager 13 is provided for the main server 110, the user side moving object manager 14, and the radar information generator 20, the radar display unit 40, the current URL manager 50 and the page display unit 60 are provided for the user terminal 130. Therefore, the network system can be sorted into several modes depending on whether the zero distance performer 32 is provided.

In FIG. 29, according to this embodiment there are two modes for the network system: an SC2-C-C type, wherein the zero distance performer 32 is provided for the user terminal 130, and an SC2-C-S type, wherein the zero distance performer 32 is provided for the main server 110 or the site server 120. According to the SC2-C-C type in FIG. 29, the user terminal 130 is in charge of (1) the exchange of data by the page display unit 60 and the zero distance performer 32 when the page display unit 60 obtains a web page or issues an event in response to the instruction for the web page, or when the page display unit 60 generates a dialogue and permits the addition of data to the dialogue; and (2) the transmission of an arrival notification or an exit notification by the radar information generator 20 to the zero distance performer 32. Further, (3) the exchange of data by the zero distance performer 32 and the general moving object manager 13 when the moving object 220 is found is performed through data communication between the main server 110 and the user terminal 130 that includes the zero distance performer 32.

According to the SC2-C-S type mode wherein the zero distance performer 32 is provided for the main server 110, (1) the exchange of data by the page display unit 60 and the zero distance performer 32 when the page display unit 60 acquires a web page or issues an event in response to the instruction for the web page, or when the page display unit 60 generates a dialogue and permits the addition of data to the dialogue; and (2) the transmission of an arrival notification or an exit notification by the radar information generator 20 to the zero distance performer 32 are effected by data communication between the user terminal 130 and the main server 110, which includes the zero distance performer 32. Further, the main server 110 is in charge of (3) the exchange of data by the zero distance performer 32 and the general moving object manager 13 when the moving object 220 is found.

According to the SC2-C-S type mode wherein the zero distance performer 32 is provided for the site server 120, (1) the exchange of data by the page display unit 60 and the zero distance performer 32 when the page display unit 60 obtains a web page or issues an event in response to the instruction for the web page, or when the page display unit 60 generates a dialogue and permits the addition of data to the dialogue; and (2) the transmission of an arrival notification or an exit notification by the radar information generator 20 to the zero distance performer 32 are effected by data communication between the user terminal 130 and the site server 120, which includes the zero distance performer 32. Further, (3) the exchange of data by the zero distance performer 32 and the general moving object manager 13 when the moving object 220 is found is effected by data communication between the main server 110 and the site server 120, which includes the zero distance performer 32.

As is described above, when as in this embodiment the management of the information concerning the moving object 220 is supported by each user terminal 130, a special moving object 220 for a specific user can appear only at a special site included in the contract site group 210.

### EXAMPLES FOR PRESENT INVENTION

As is described above, according to the embodiments of the invention, a user is permitted to search for the moving object 220, so that the user is guided to predetermined content (a web page) on the network. Multiple moving objects 220 may be employed for a search performed by the user. Further, a special object (a special offer to be provided for the person who acquires the object) may appear for a limited time period. Further, a user may be guided to desired content using a specific order corresponding to that whereat the moving object 220 is moved (appears).

Further, as in the second and third embodiments, positional information concerning the moving object 220 is managed and controlled by each user terminal 130, so that the type of the moving object 220 that appears on user terminals 130 can be controlled. For example, before the moving object manager 12 or 14 is provided for a user, the category of the hobby of the user is registered, and when the moving object 220 appears in the contents of the category that corresponds to the hobby of the user, the position of the moving object 220 is indicated by the radar display unit 40 of the user terminal 130.

Further, when the user is guided to a specific web page, an advertisement for the web page can be provided. In this case, since all the users who are searching for the moving object 220 can be guided, regardless of the type of web page, a larger number of users than those obtained by a banner advertisement or by the registration at a search site can be guided to the web page (i.e., regardless of whether the users are interested in the contents of the web page). Since the users who visit the web page are not always interested in it, useful information is not always provided for these users. However, since some users who are not originally interested in the pertinent web page may later become interested in it, effects can be acquired that are not possible when only banner advertisements or registrations at search sites are used.

The charging form when the present invention is employed for the advertisement of a predetermined content will now be descried.

When the present invention is used for the advertisement of a web page, a constant number of users are guided to the content, so that an advertisement fee is received as compensation from an advertiser. In this case, it is important to establish what the advertiser can be guaranteed as the result of users being guided to a web page. The following items can be presumed to be guaranteed.

(1) Guarantee the number of visits that users will make to a site (guarantee of visits)

The number of users who visit a site is guaranteed, and a fee is charged in accordance with the guaranteed number of visiting users. In this case, the moving object 220 appears in the contract site a predetermined number of times, and the number of times that the moving object 220 is found is regarded as the number of visits.

(2) Guarantee the probability that a user will visit a site (guarantee of probability)

The probability that a user will visit a site during a predetermined period of time is guaranteed. The visit probability is the ratio of the number of users that visit the site to the total number of users (population) that participate in the search for the moving object 220. When the search for the moving object 220 is more popular and can more reliably collect users, the visiting probability is increased, and a high contract price can be charged.

(3) Guarantee of the probability that a user will scan a specific site (guarantee of scanning ratio)

The pages that users visit are monitored, and the ratio of these pages to all the pages belonging to the contract site is guaranteed. When a service provided by a predetermined site is not well known, the moving object 220 frequently appears in the contents for the predetermined site, so that more users will visit the site. Thus, awareness of the service contents of the site can be effectively disseminated.

In the above embodiments, under a condition whereby the moving object 220 is found by a specific user (where the icon of the moving object 220 or the link to the moving object 220 is clicked on), the moving object 220 is moved to another content (web page). Further, when the user approaches within a predetermined range (the distance between the web page that the user is browsing and the moving object 220 is equal to or less than a predetermined distance) and before the user finds the moving object 220, the moving object can be moved. When the moving object 220 is moved while a specific distance from the user is maintained, the user can be guided along a desired route.

Furthermore, instead of waiting until the user clicks on the icon of the moving object 220, or the link to the moving object 220, when the user starts browsing the web page whereat the moving object 220 is located, it may be ascertained that the user has found the moving object 220. In this case, the process in each embodiment concerning the exiting of the web page is not required.

In addition, a web page that a specific user is browsing may also be regarded as the web page whereat the moving object 220 is located. With this configuration, when the user that has acquired the moving object 220 travels among the web pages, the moving object 220 is moved in accordance with the user's intention. Further, when the location of the web page that another user is browsing is displayed on the radar display unit 40 of the user who acquired the moving object 220, the user who acquired the moving object 220 can become aware of the presence of another user who is tracing him or her, and can escape from that user. As a result, the users can participate in a type of game, much like playing tag.

As is described above, according to the present invention, means for guiding a user to a specific site group can be provided, regardless of whether or not the user has an interest in the contents of the site.

In addition, according to the present invention, a moving object for traveling among the members of a specific site group can be provided in order to guide a user to web pages in the site group.

1. A user guidance method comprising the steps of:
permitting an object, which is so defined that it can be obtained by a user, to appear at a specific location of a specific site; and
moving said object,
whereby a user who desires to obtain said object is guided to predetermined content available at said specific site.

2. The user guidance method according to claim 1, wherein said step of moving said object includes the steps of:
waiting, after said object has appeared at said specific location, until said object is obtained by users; and
permitting said object, after said object has been obtained by any of said users, to appear at a different location at said specific site.

3. The user guidance method according to claim 1, further comprising the step of:
providing information, after said object has appeared, concerning the location of said object for said user who desires to obtain said object.

4. The user guidance method according to claim 1, wherein, at said step of moving said object, said object is moved along a predetermined route, and said user who desires to obtain said object is guided to said predetermined content in accordance with a specific order based on said route.

5. The user guidance method according to claim 1, wherein, at said step of permitting said object to appear, said object appears at specific locations at multiple connected sites across a network; and wherein at said step of moving said object, said object is moved across said network.

6. The user guidance method according to claim 5, wherein, at said step of moving said object, said object is moved along a predetermined route across said multiple sites on said network, and said user who desires to obtain said object is guided to predetermined content available in a specific sequential order based on said route.

7. A content advertisement method comprising the steps of:
permitting an object, defined so that it can be obtained by a user, to appear on a network in contents multiple users desire to browse; and
moving said object, when a predetermined user browses said contents, to contents multiple users desire to browse,
whereby said user, who desires to obtain said object, is guided to and enabled to browse said contents.

8. The content advertisement method according to claim 7, wherein, at said step of moving said object, movement of said object is effected along a route that includes said contents multiple users desire to browse.

9. A user guidance system comprising:
an object manager for managing the location of an object on a network;
a position information generator for generating information concerning said location of said object, and for providing said information to a user who is accessing said network; and
a processor for, when said object is selected by a predetermined user, performing a predetermined process associated with the object selection,
wherein said object manager arranges said object at a desired location in order to guide said user to desired contents on said network.

10. The user guidance system according to claim 9, wherein, when said object is selected, said processor transmits a notification to that effect to said object manager, and upon the receipt of said notification, said object manager deletes said object selected by said user, and positions another object at a different location on said network.

11. A user guidance system according to claim 9, wherein, when said object is selected by a specific user, said processor transmits, together with information concerning said specific user, a notification to that effect to said object manager; wherein, upon the receipt of said notification, said object manager manages said information concerning said specific user, who is regarded as the person who has obtained said object; wherein, if said object is selected by multiple users, only said specific user is regarded as the person who has obtained said object.

12. An object control system comprising:
web servers, for storing web pages; and
a main server, for communicating with a predetermined web server,
wherein said main server permits a specific object to appear in a specific web page or delete from a specific web page stored in said specific web server.

13. The object control system according to claim 12, wherein said object is selected when said object is present in a web page that a user is currently browsing; and wherein, when said object is selected by said user, said main server deletes said object from said web page and permits said object to appear in another web page.

14. The object control system according to claim 12, wherein said main server provides, for said user who accesses said specific web server, information concerning the location of said object that is appearing.

15. The object control system according to claim 14, wherein said information concerning said location of said object, which is provided for said user, indicates the ease with which said object can be reached from said web page browsed by said user.

16. An object control system comprising:
an object to be embedded in a web page stored at a web site on a network; and
object management means for managing the location of said object on said network,
wherein said object management means changes the location of said object on said network in order to move said object across said network.

17. The object control system according to claim 16, wherein said object management means correlates the location of said object with a web page browsed by a predetermined user, and changes said location of said object web pages are browsed by said user.

18. An object control system comprising:
an object stored in a predetermined server;
link setting means, for setting a link in a web page stored at a web site on said network in order to move to said object; and
object position management means, for determining a web page for setting a link thereto,
wherein, under the control of said object position management means, said link setting means changes a target web page for setting a link thereto.

19. The object control system according to claim 18, wherein said object position management means defines a web page browsed by a predetermined user as said target web page to which said link with said object is to be set, and changes said target web page as said predetermined user browses said web pages; and wherein said link setting means, under the control of said object position management means, changes said link with said object.

20. A moving object, to be embedded in a web page stored at a web site on a network, whose location on said network is managed by specific management means, and which moves from a predetermined web page to another web page.

21. A storage medium on which input means of a computer stores a program in an input-enabled form, said program permitting said computer to perform:
a process for permitting a specific object to appear on a specific web page stored in a specific web server;
a process for, when a user browses said specific web page and selects said specific object, moving said object to another web page.

22. A program transmission apparatus comprising:
storage means for storing a program permitting a computer to perform
a process for permitting a specific object to appear on a specific web page stored in a specific web server,
a process for, when a user browses said specific web page and selects said specific object, moving said object to another web page; and
transmission means for reading said program from said storage means and for transmitting said program.
